(19) United States
(12) Patent Application Publication
(10) Pub. No.: US 2019/0251123 A1
(43) Pub. Date: Aug. 15, 2019

(54) APPARATUS, METHOD AND PROGRAM FOR SHORTEST PATH MATRIX GENERATION

(71) Applicant: FUJITSU LIMITED, Kawasaki-shi (JP)

(72) Inventor: Yasuo Yamane, Machida (JP)

(73) Assignee: FUJITSU LIMITED, Kawasaki-shi (JP)

(21) Appl. No.: 16/272,216

(22) Filed: Feb. 11, 2019

(30) Foreign Application Priority Data
Feb. 13, 2018 (JP) 2018-023307

(51) Int. Cl. G06F 16/901; G06F 16/28; G06F 16/248; G06F 16/2458

(52) U.S. Cl. CPC G06F 16/9024; G06F 16/2458; G06F 16/248; G06F 16/285

(57) ABSTRACT

A shortest path matrix generation method includes assigning, in a graph represented by a plurality of vertexes and edges connecting the vertexes, identification information to respective intermediate paths including two or more of the edges on a shortest path between each vertex. The method may also include generating, as values of respective elements of a matrix representing the shortest path from all the vertexes to all the vertexes included in the graph, the shortest path matrix using the identification information of the intermediate paths on the shortest path between the vertexes corresponding to a row and a column corresponding to the respective elements.

### CROSS-REFERENCE TO RELATED APPLICATION

This application is based upon and claims the benefit of priority of the prior Japanese Patent Application No. 2018-23307, filed on Feb. 13, 2018, the entire contents of which are incorporated herein by reference.

### FIELD

The embodiment discussed herein is related to a shortest path matrix generation program, a shortest path matrix generation apparatus, and a shortest path matrix generation method.

### BACKGROUND

In recent years, the number of applications utilizing network-based data has been increasing in the fields of social networking services (SNSs), customer relationship management, network management, bioengineering, transportation, and so on. The network-based data is data indicating elements and relationships between the elements. Examples of the network-based data include data indicating human relationships, relationships between molecules, and the so-called networks, such as the Internet, a communication network, a traffic network, and a transportation network.

The network-based data may also be represented by a graph including vertexes corresponding to respective elements and edges connecting the vertexes, the edges corresponding to relationships between related elements. For example, in a graph of network-based data indicating a human relationship, each human may be represented by a vertex as one element, and a relationship between the humans may be represented as an edge connecting the vertexes.

When a set of vertexes included in a graph G is represented by V, and a set of edges is represented by E, the graph G is represented as G=(V, E). In a graph, two vertexes connected through one edge are said to be adjacent to each other. When a vertex vᵢ₋₁ and a vertex vᵢ are adjacent to each other in a sequence of vertexes v₀, v₁, . . . , and vₙ for any i where 1≤i≤n, the sequence of vertexes is referred to as a “path”, and the length thereof is n at the maximum. The vertex v₀ is referred to as a “start point” of the path, and the vertex vₙ is referred to as an “end point” of the path. Of paths between two vertexes, the path having the shortest length is referred to as a “shortest path”, and the length of the shortest path between two vertexes is referred to as a “distance”.

Graphs like those described above are grouped into an undirected graph in which the edges are not directed and a directed graph in which the edges are directed. For example, when all roads are able to be traveled in both directions, this road network may be represented as an undirected graph. However, a road network including a one-way road is able to be represented only by a directed graph. The definitions described above are predicated on an undirected graph.

Graphs of network-based data as described above may be grouped into a weighted graph in which each edge is weighted and an unweighted graph in which each edge is not weighted. For example, a railway network may be represented as a weighted graph by associating stations with respective vertexes, connecting the vertexes corresponding to the adjacent stations by using edges, and assigning each edge a weight corresponding to the distance between the stations. On the other hand, for network-based data representing a human relationship, when attention is paid to only the presence/absence of a relationship and the intimacy of the relationship is not considered, the human relationship may be represented by an unweighted graph.

Meanwhile, there are increasing demands for data analysis involving, for example, extracting information important for business, management, research, and so on from the network-based data. There are also demands for data analysis for graphs representing network-based data. For example, determining the shortest path between two vertexes in a graph is important for data analysis for the graph.

Three examples in which an unweighted undirected graph is effective will be described below. For example, for network-based data representing a human relationship, a graph is conceivable in which people who are friends with each other in an SNS, people that exchange email in-house, or the like are connected to each other by using edges. Now, consider a case in which one person who is represented as a vertex in the graph wishes to access another person who has no direct relationship with that person. In this case, in the graph, when the shortest path between vertexes representing the two people is known, it is possible to contact an intended person through an acquaintance corresponding to a vertex on the path with the least time and effort.

In a graph representing a computer network, when the shortest path between vertexes is known, communication may be performed between apparatuses corresponding to the vertexes through the path with which the number of communications is the smallest.

For example, consider a graph in which vertexes correspond to respective facets of a Rubik's Cube (registered trademark) and the facets between which a transition may be made by a single turn are connected by an edge. In this case, the shortest path from the vertex corresponding to one facet to the vertex corresponding to the final facet (the state in which each of all of the faces has one color) represents an optimal solution (a minimum number of moves).

There is a technique for expressing the shortest path between two vertexes in a graph as a shortest path tree (one dimensional array). As an example of a technique for expressing a shortest path using a path tree, an apparatus for detecting the shortest path between three or more nodes in a communication network has been offered. In this apparatus, path information of a communication network including all nodes, paths, lengths of respective paths, basic closed loops and designated nodes is input. This apparatus configures a reference partial network by the shortest path of each designated node pair, detects an intermediate node other than the designated node in the reference partial network, decomposes the closed path included in the reference partial network into a predetermined basic closed path, and detects intermediate nodes in the basic closed loop. This device configures a comparative partial network composed of the selected partial node and the designated node constitute, and compares the shortest tree length of the reference partial network and the shortest tree length of the comparative partial network. Related techniques are disclosed in, for example, Japanese Laid-open Patent Publication No. 08-195807.

With respect to the shortest path from all the vertexes to all the vertexes in the graph, for each vertex, the shortest path from one vertex to the other all vertexes may be expressed as a shortest path tree (one dimensional array), and the shortest path tree group of the entire graph may be expressed as a shortest path matrix (two-dimensional array). Since it takes a lot of time to determine the shortest path from all the vertexes to all the vertexes, the shortest path between each vertex is previously determined in the form of the shortest path matrix, and stored in the storage unit such as a main storage or a secondary storage. It is possible to read the shortest path matrix from the storage unit, and restore the corresponding shortest path to respond when receiving an inquiry about the shortest path specifying the vertex.

For example, in the railway network, the shortest path to one station from the other stations is determined for each station, and is expressed in the form of the shortest path matrix, and the shortest path matrix is stored in the storage unit. When receiving an inquiry about the shortest path between any two stations from the user, the shortest path tree between the corresponding two stations is read out from the shortest path matrix stored in the storage unit, and the shortest path indicated by the shortest path tree is replied. This makes it possible to respond quickly to the inquiry about the shortest path.

However, when the number of stations is n, the simple method requires the memory amount of O(n) to hold the shortest path tree for each station, and the required amount of memory for holding the shortest path matrix for the entire station is O(n²). O(x) means that it is a multiple of x, for example, it is proportional to x. The size (data amount) of the shortest path matrix is enormous in a graph having a large number of vertexes such as a road network. For example, when the data amount per element of the shortest path matrix is 4 bytes for a graph having 100 million vertexes, the shortest path matrix requires a size of 40 peta (=4×10⁸×10⁸) bytes.

Therefore, when the shortest path matrix is stored in the storage unit, it is possible to greatly reduce its size by compressing and storing the shortest path matrix.

However, in a case where the shortest path matrix generated by using the related art is compressed and stored, it takes time to restore the shortest path between the requested two vertexes from this compressed shortest path matrix.

As one aspect, an object of the disclosed technique is to generate a shortest path matrix for which a shortest path may be rapidly restored wherein the shortest path matrix represents the shortest path between vertexes included in a graph.

### SUMMARY

According to an aspect of the embodiments, a shortest path matrix generation method includes; assigning, in a graph represented by a plurality of vertexes and edges connecting the vertexes, identification information to respective intermediate paths including two or more of the edges on a shortest path between each vertex; and generating, as values of respective elements of a matrix representing the shortest path from all the vertexes to all the vertexes included in the graph, the shortest path matrix using the identification information of the intermediate paths on the shortest path between the vertexes corresponding to a row and a column corresponding to the respective elements.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a graph;

FIG. 2 is a diagram illustrating an example of a shortest path tree;

FIG. 3 is a diagram illustrating an example of an array representing a shortest path tree;

FIG. 4 is a diagram illustrating an example of a shortest path matrix;

FIG. 5 is a functional block diagram of an information processing apparatus according to a reference example;

FIG. 6 is a flowchart illustrating an example of a shortest path matrix generation process in the reference example;

FIG. 7 is a flowchart illustrating an example of the shortest path restoration process in the reference example;

FIG. 8 is a functional block diagram of an information processing apparatus according to an embodiment;

FIG. 9 is a flowchart for explaining a breadth-first search algorithm;

FIG. 10 is an example of a graph for explaining a breadth-first search algorithm;

FIG. 11 is a diagram for explaining generation of a shortest path matrix by a breadth-first search algorithm;

FIG. 12 is a block diagram illustrating a schematic configuration of a computer functioning as the information processing apparatus according to the embodiment;

FIG. 13 is a flowchart illustrating an example of a shortest path matrix generation process in the embodiment;

FIG. 14 is a flowchart illustrating an example of a table generation process;

FIG. 15 is a flowchart illustrating an example of a matrix generation process;

FIG. 16 is a flowchart illustrating an example of a (k, m′) acquisition process;

FIG. 17 is a diagram illustrating an example of a graph for explaining a specific example;

FIG. 18 is a diagram illustrating an example of a clustering result in the specific example;

FIG. 19 is a diagram for explaining generation of a shortest path matrix in the embodiment;

FIG. 20 is a diagram for explaining generation of a shortest path matrix in the embodiment;

FIG. 21 is a flowchart illustrating an example of a shortest path restoration process in the embodiment;

FIG. 22 is a diagram for explaining a comparison of the number of accesses between the comparison method and the present method;

FIG. 23 is a diagram illustrating a comparison result of the number of accesses between the comparison method and the present method;

FIG. 24 is a diagram illustrating an example of clustering;

FIG. 25 is a diagram illustrating a comparison result of the number of accesses by the number of divisions; and

FIG. 26 is a diagram for explaining generation of a shortest path matrix of a disconnected graph.

### DESCRIPTION OF EMBODIMENTS

In the embodiment described below, with respect to each of the vertexes included in a graph including the vertexes and the edges connecting the vertexes, a shortest path matrix that represents shortest paths to the other vertexes is generated.

First, before describing the details of the embodiment, the outline of the shortest path matrix will be described.

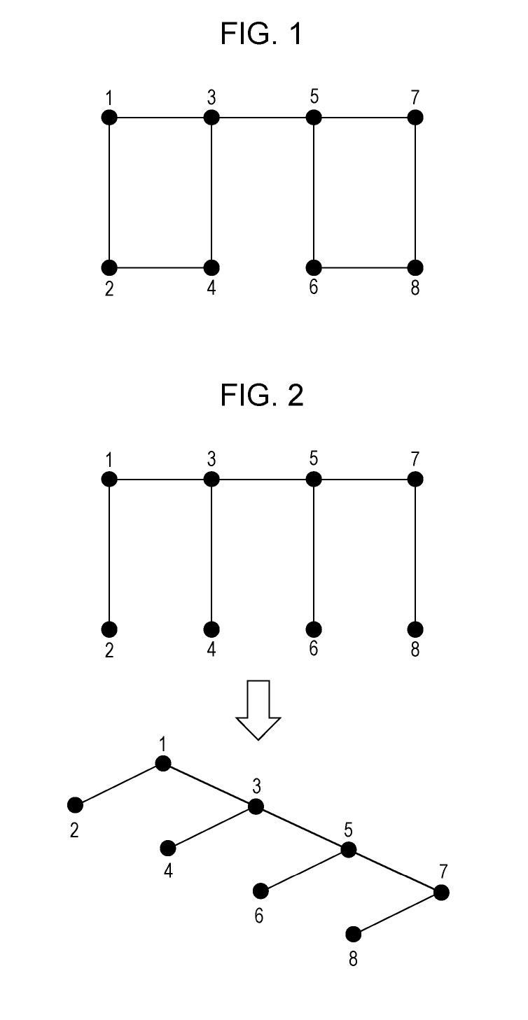

An example of a graph is illustrated in FIG. 1. In FIG. 1, the vertexes are represented by black circles, and the numbers appended to the vertexes represent the vertex identification numbers (hereinafter referred to as “vertex numbers”). The same applies to the subsequent drawings. In this specification, vertex numbers from 1 to n are assigned to n vertexes of the graph to identify each vertex. Hereinafter, the vertex of the vertex number x is denoted as “vertex x”.

Consider the shortest path from each vertex to vertex 1 in the graph illustrated in FIG. 1. The shortest path of this graph may be represented by the shortest path tree as illustrated in FIG. 2.

In general, when the number of vertexes included in the shortest path tree is n, the number of edges included in the shortest path tree is n−1. The shortest path tree may be depicted in a form like a tree that is turned upside down, in such a manner that one vertex is located at the top, vertexes (group) connecting thereto are located therebelow, and vertexes (group) connecting the vertexes (group) are further located therebelow. In this case, the top vertex is referred to as the “root”. A vertex that does not have a vertex below its vertex is referred to as a “leaf”. A vertex w that connects directly below a vertex v is the child of the vertex v, and the vertex v is referred to as the parent of the vertex W.

The upper diagram of FIG. 2 is an example of the shortest path tree with a vertex 1 which is the end point of the shortest path as the root, and the lower diagram of FIG. 2 is an example of the shortest path tree with the root represented at the top. For example, the shortest path from a vertex 6 to a vertex 1 may be determined as a sequence of vertexes that pass from the vertex 6 through its parent sequentially until reaching the vertex 1.

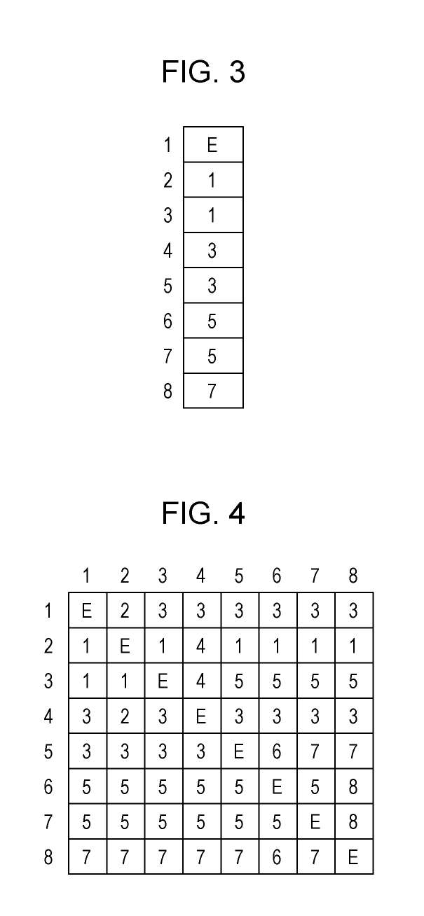

The shortest path tree with vertex 1 as the root may be expressed as an array as illustrated in FIG. 3. In the example of FIG. 3, the i-th element of the array stores the vertex number of the vertex to be traced next when traced from the vertex i to the vertex 1, for example, the vertex number of the parent of the vertex i in the shortest path from the vertex i to the vertex 1. Since the vertex 1 is the end point of the shortest path and its parent does not exist, a value indicating that the parent does not exist is stored in the element of the array corresponding to the vertex 1. The value is a value that may not be taken as the value of the shortest path matrix, for example, the largest integer value, and here, the value is represented by E. For example, the vertex corresponding to the element in which E is stored indicates that it is the end point of the shortest path.

For the graph illustrated in FIG. 1, FIG. 4 illustrates the shortest path matrix in which an array illustrating the shortest path tree from all the vertexes to all the vertexes is arranged in order from the array corresponding to vertex 1 to the array corresponding to vertex 8 is expressed as a two-dimensional array. In the case of restoring the shortest path from such shortest path matrix, L elements of the shortest path matrix are required to be accessed when the length of the shortest path is L. Since the input/output count for the disk is roughly proportional to the number of accesses to the elements of the shortest path matrix, reducing the number of accesses to the shortest path matrix may reduce the input/output count for the disk and the shortest path may be restored at high speed from the shortest path matrix.

Therefore, in the following embodiment, not only the above-mentioned vertex number of the parent, but also the identification information of the path (hereinafter referred to as an “intermediate path”) having a length of 2 or more appearing on the shortest path are used as the values of the elements of the shortest path matrix.

As the intermediate path, there are a point (hereinafter referred to as an “intermediate point”) and an edge (hereinafter referred to as an “intermediate edge”) appearing on the shortest path. The intermediate point may be regarded as an intermediate path having a length of 0 and the intermediate edge may be regarded as an intermediate path having a length of 1. However, in the following embodiment, as will be described in detail later, since the aim is to restore the shortest path at high speed, the intermediate path having a length of 2 or more is processed. In the following, for simplicity of explanation, an unweighted undirected graph as illustrated in FIG. 1 will be described as an example. Since there is no weight, the length of each edge is taken as 1. Therefore, a path having a length of 2 or more means a path including two or more edges.

### Reference Example

Next, in order to aid understanding of the embodiment described in detail below, a case of using the identification information of the intermediate point and the intermediate edge as the value of the element of the shortest path matrix will be described as a reference example.

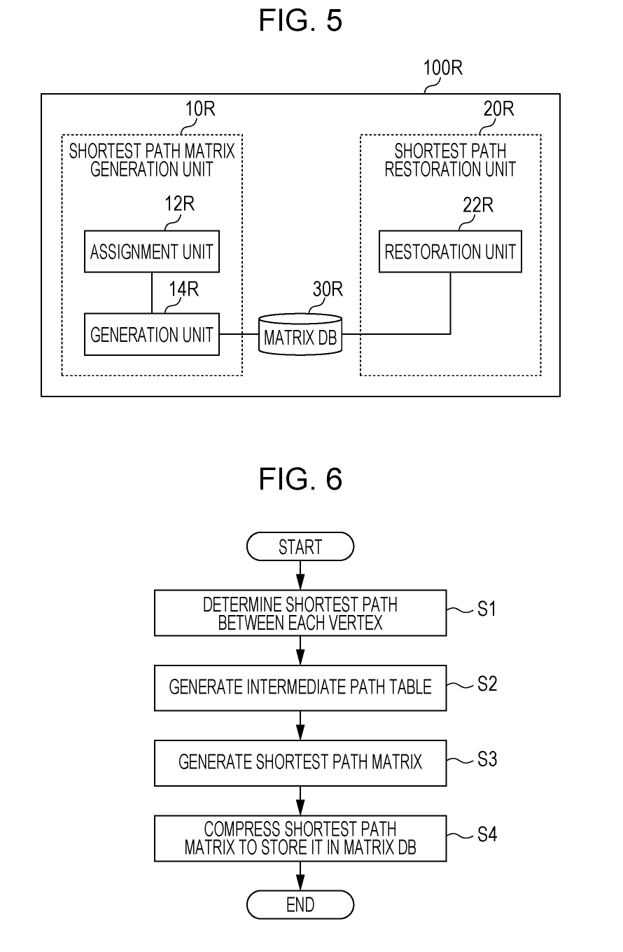

FIG. 5 is a functional block diagram of an information processing apparatus 100R according to the reference example. The information processing apparatus 100R includes a shortest path matrix generation unit 10R including an assignment unit 12R and a generation unit 14R, and a shortest path restoration unit 20R including a restoration unit 22R.

The assignment unit 12R determines the shortest path between each vertex included in the graph. A known method may be used for determining the shortest path. The assignment unit 12R assigns identification information for use as the value of the element of the shortest path matrix to each of the intermediate point and the intermediate edge which are the intermediate path on the shortest path. As described above, since vertex numbers from 1 to n are assigned to the n vertexes of the graph, these vertex numbers are used as the identification information of the intermediate point as they is. The edge identification information is generally represented by a set of vertex numbers of vertexes at both ends of the edge. Identification information of this edge may be used as identification information of the intermediate edge. In this case, however, since the data amount of the identification information of one intermediate edge corresponds to the data amount of two vertex numbers, identification information with a small data amount may be reassigned. In the reference example, the assignment unit 12R assigns identification information n+1, n+2, . . . to each of the intermediate edges with n being the total number of vertexes. Hereinafter, the identification information assigned to the intermediate edge by the assignment unit 12R will be referred to as an “intermediate edge number”.

The assignment unit 12R generates two intermediate path tables P₁ and P₂ in which the intermediate edge and the intermediate edge number assigned to the intermediate edge are associated with each other and are stored. P₁ is used for shortest path matrix generation, and P₂ is used for shortest path matrix restoration. It is unnecessary to assign intermediate edge numbers to all the intermediate edges, and an intermediate edge number may be assigned to only the intermediate edge used in the shortest path matrix and stored in the intermediate path table. This makes it possible to reduce the size of the intermediate path table. The intermediate path table may include an index attached table such as a hash table. In the following, in the intermediate path table P₁, a record indicating that the intermediate edge number “x” is assigned to the intermediate edge having the vertexes k₁ and k₂ at both ends is denoted as P₁[(k₁, k₂)]=x. To the contrary, in P₂, the intermediate edge number correspond to the intermediate edge, so that P₂[x]=(k₁, k₂).

The generation unit 14R generates the shortest path matrix using the vertex numbers of the vertexes (including the intermediate point) on the shortest path between the vertexes corresponding to the row and column corresponding to each element and the intermediate edge numbers of the intermediate edges as the value of each element of the matrix representing the shortest path from all the vertexes to all the vertexes included in the graph.

Consider generation of the shortest path matrix using the vertex number of the intermediate point. A shortest path from vertex i to vertex j, for example, a sequence of vertexes from vertex i to vertex j, is represented as σ[i, j]. For example, in the graph illustrated in FIG. 1, the shortest path from vertex 8 to vertex 1, for example, σ[8, 1], is 8, 7, 5, 3, 1. This is expressed as σ[8, 1]=[8, 7, 5, 3, 1].

When the shortest path matrix is expressed as S, the element of row i and column j of the shortest path matrix S is denoted as S[i, j]. S[i, j] stores not only the vertex number of the parent of vertex i in the shortest path from vertex i to vertex j, but also the vertex number of the intermediate point on the shortest path from vertex i to vertex j. For example, when the intermediate point is not used for the shortest path matrix of the graph illustrated in FIG. 2, S[8, 1]=7 as illustrated in FIG. 4. The generation unit 14R may set S[8, 1]=3, for example, using the intermediate point of σ[8, 1].

For example, the generation unit 14R acquires intermediate points from the information of the shortest path σ[i, j] determined by the assignment unit 12R. The generation unit 14R stores the vertex number of the intermediate point selected from the acquired intermediate points as the value of the element of S[i, j]. Any method may be used for selecting the vertex number, wherein the method, for example, may include randomly selecting, selecting the smallest vertex number, and selecting the vertex number having the highest appearance frequency out of the vertex numbers already selected as values of other elements.

As in the case of the intermediate point, consider generation of the shortest path matrix using the intermediate edge number of the intermediate edge. When the intermediate points acquired from the information of the shortest path σ[i, j] determined by the assignment unit 12R include a set of intermediate points constituting edges, the generation unit 14R may store the intermediate edge number of the intermediate edge constituted by the set of the intermediate points as the value of the element of S[i, j]. For example, as in the case of the above-described intermediate point, the generation unit 14R acquires the intermediate edge from the information of the shortest path σ[i, j] and selects an intermediate edge used as the value of the element of the shortest path matrix from among the acquired intermediate edges. When the intermediate edge is selected, the intermediate path table P₁ generated by the assignment unit 12R is referred to. The generation unit 14R acquires the intermediate edge number of the selected intermediate edge from the intermediate path table P₁ and stores it as the value of the element of S[i, j].

The generation unit 14R compresses the generated shortest path matrix S. Since the shortest path matrix S has the data structure same as that of the image of n pixels×n pixels, it may be compressed using a lossless image compression algorithm or the like. The generation unit 14R stores the compressed shortest path matrix S together with the intermediate path table P₂ generated by the assignment unit 12R in the predetermined storage area of a matrix database (DB) 30R.

The generation unit 14R may also compress the intermediate path table P₂ and store it in the matrix DB 30R. Existing compression techniques may be used to compress the intermediate path table P₂. For example, in a case where a B-tree is use as an index, data is internally sorted in key order, so that it is possible to compress the prefix of the key. The compression method may be simply used for any intermediate path table, and the compression may be performed per page in input and output using existing information compression technology.

Upon receiving an inquiry about the shortest path whose start point and end point are designated, the restoration unit 22R uses the shortest path matrix S stored in a matrix DB 30R and the intermediate path table P₂ while decompressing it, and restores the shortest path between vertexes corresponding to the designated start point and end point to be restored.

For example, in a case where the vertex corresponding to the designated start point is i (hereinafter referred to as “start point i”) and the vertex corresponding to the end point is j (hereinafter referred to as “end point j”), for example, when σ[i, j] is determined, the restoration unit 22R acquires the value k₁ of S[i, j] from the shortest path matrix S. First, a case where the value of S[i, j] is an intermediate point number will be described. σ[i, j] may be determined as the sum of σ[i, k₁] and σ[k₁, j] (a combination of two shortest paths connected by the vertex k₁). The restoration unit 22R acquires the value k₂ of S[i, k₁] as the intermediate point for σ[i, k₁] and determines σ[i, k₁] as the sum of σ[i, k₂] and σ[k₂, k₁]. Similarly for σ[k₁, j], the restoration unit 22R acquire the value k₃ of S[k₁, j], and determines σ[k₁, j] as the sum of σ[k₁, k₃] and σ[k₃, j]. The restoration unit 22R recursively repeats the above process until the shortest paths divided at the intermediate point are connected as one path, thereby determining the whole shortest path.

In a case where the value obtained from S[i, j] is the intermediate edge number x of the intermediate edge, the restoration unit 22R refers to the intermediate path table P₂, and specifies the vertex numbers k₁ and k₂ of the vertexes at both ends of the intermediate edge from P₂[x]=(k₁, k₂). The restoration unit 22R restores σ[i, k₁] and σ[k₂, j] at the edges (k₁, k₂) as σ[i, j] in the same manner as described above.

When the intermediate point k coincides with the start point i or the end point j in the shortest path σ[i, j] having a length of 2 or more, the shortest path may not be restored. For example, in the case of k=i, σ[i, j] is the sum of σ[i, i] and σ[i, j], resulting in σ[i, j] which is the same as the original one, and recursive processing may not be repeated. The same applies to the case of k=j. Therefore, in a case where σ[i, j] is the shortest path having a length 2 or more, start point i and end point j may not be the intermediate point. In a case where σ[i, j] is the shortest path having a length of 1, for example, when the start point i and the end point j are adjacent to each other, when the intermediate point k coincides with the start point i as in the above case, the shortest path may not be determined. The case of k=j does not matter because this case is the same as a case where the vertex number of the parent is used. Therefore, in a case where σ[i, j] is the shortest path having a length 1, the start point i may not be the intermediate point.

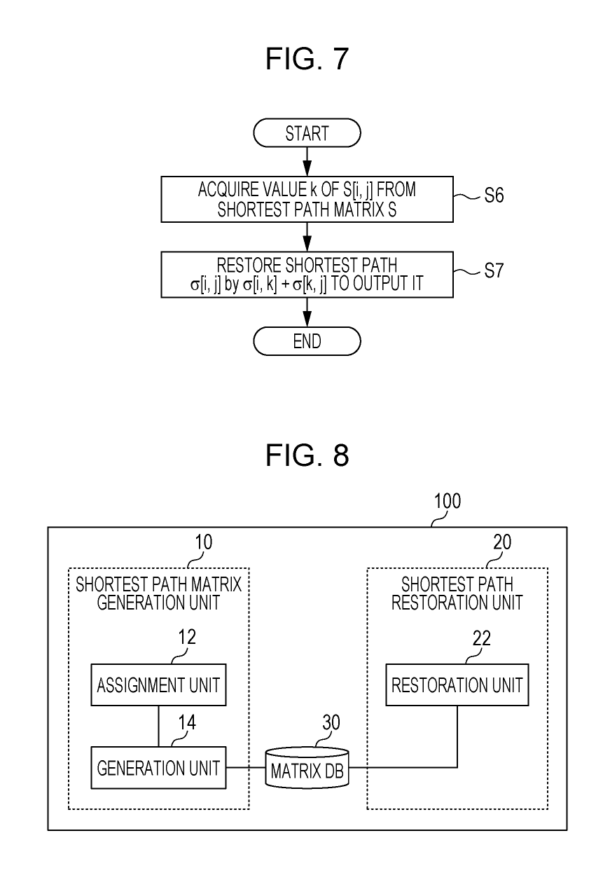

Next, the operation of the information processing apparatus 100R according to the reference example will be described. First, when a graph G (G=(V, E)) is input to the information processing apparatus 100R and generation of the shortest path matrix is instructed, a shortest path matrix generation process illustrated in FIG. 6 is performed in the shortest path matrix generation unit 10R of the information processing apparatus 100R. When a search request for the shortest path σ[i, j] is accepted in a state where the shortest path matrix is generated and stored in the matrix DB 30R, a shortest path restoration process illustrated in FIG. 7 is performed in the shortest path restoration unit 20R of the information processing apparatus 100R. Hereinafter, the shortest path matrix generation process and the shortest path restoration process in the reference example will be described in detail.

First, in step S1 of the shortest path matrix generation process illustrated in FIG. 6, the assignment unit 12R determines the shortest path between each vertex (1, . . . , N) included in the input graph G. The assignment unit 12R assigns the intermediate edge number (n+1, n+2, . . . ) to each of the shortest paths. In step S2, the assignment unit 12R generates an intermediate path tables (P₁[(k₁, k₂)]=x, and P₂[x]=(k₁, k₂)) in which the intermediate edge (k₁, k₂) and the intermediate edge number (x) which is assigned to the intermediate edge are associated with each other and are stored.

Next, in step S3, the generation unit 14R generates a shortest path matrix. The value of each element of the matrix represents the shortest path from each of all the vertexes to all the vertexes included in the graph, and is determined by the following procedure. First, the generation unit 14R acquires the vertex number of the intermediate point of σ[i, j] from the information of the shortest path determined by the assignment unit 12R. The generation unit 14R selects a vertex number or an intermediate edge used as a value of an element of the shortest path matrix from the vertex numbers of the acquired intermediate points. When selecting the intermediate edge, the generation unit 14R acquires an intermediate edge number from the intermediate path table P₁ generated by the assignment unit 12R, and stores the selected vertex number or intermediate edge number as the value of the element of S[i, j].

Next, in step S3, the generation unit 14R compresses the generated shortest path matrix S and stores the compressed shortest path matrix S together with the intermediate path table P₂ generated by the assignment unit 12R in the predetermined storage area of the matrix DB 30R. The shortest path matrix generation process ends.

Next, the shortest path restoration process illustrated in FIG. 7 will be described.

In step S6, the restoration unit 22R acquires the value k of S[i, j] from the shortest path matrix S stored in the matrix DB 30R with respect to the inquiry about the accepted shortest path σ[i, j]. In a case where k is the vertex number of the intermediate point, the restoration unit 22R determines σ[i, j] as the sum of σ[i, k] and σ[k, j]. In a case where k is the intermediate edge number of the intermediate edge, the restoration unit 22R specifies the intermediate edge (k₁, k₂) corresponding to k from the intermediate path table P₂. The restoration unit 22R determines σ[i, j] by combining σ[i, k₁] and σ[k₂, j] at the intermediate edge (k₁, k₂). Regarding σ[i, k], σ[k, j], σ[i, k₁], σ[k₂, j], and the like, the restoration unit 22R also repeats recursively the processes of steps S6 and S7 until the shortest paths divided by the intermediate point or the intermediate edge are connected as one path. As a result, the restoration unit 22R restores the whole shortest path σ[i, j], outputs the restored shortest path σ[i, j], and ends the shortest path restoration process. When accessing the shortest path matrix and intermediate path table P₂, the restoration unit 22R performs decompression processing.

### EMBODIMENT

Hereinafter, an example of the embodiment according to the disclosed technology will be described in detail with reference to the drawings. In the present embodiment, details common to those of the reference example will be omitted.

As described above, in the present embodiment, the intermediate path having a length of 2 or more is processed. The reason for this will be explained with reference to the above reference example.

In the reference example, the case of using the vertex number of the intermediate point or the intermediate edge number of the intermediate edge on the shortest path as the value of the element of the shortest path matrix has been described. In this case, the number of accesses to (elements of) the shortest path matrix and the intermediate path table increases at the time of restoration of the shortest path. As the number of accesses to the shortest path matrix and the intermediate path table increases, it takes time to restore the shortest path.

For example, an example of the shortest path σ[8, 1]=[8, 7, 5, 3, 1] in the graph of FIG. 2 will be described. When only the vertex number of the parent is used as the value of the element of the shortest path matrix, since the vertex number “7” of the vertex 7, which is the parent of the vertex 8, is stored in S[8, 1], then S[7, 1] is accessed. Since “5” is stored in S[7, 1], then S[5, 1] is accessed. Since “3” is stored in S[5, 1], then S[3, 1] is accessed. Since the end point “1” is stored in S[3, 1], it is determined that the shortest path σ[8, 1] is [8, 7, 5, 3, 1] at this point, and S[1, 1] may not be accessed. For example, the number of accesses to the shortest path matrix is four of S[8, 1], S[7, 1], S[5, 1], and S[3, 1]. Generally, in a case where only the vertex number of the parent is used as the value of the element of the shortest path matrix, the number of accesses to the shortest path matrix to determine the shortest path having a length L is L.

In a case where the vertex number of the intermediate point is used as the value of the element of the shortest path matrix, the number of accesses to the shortest path matrix is increased by one each time an intermediate point is included. For example, suppose that S[8, 1]=5. In this case, σ[8, 1]=σ[8, 5]+σ[5, 1], where σ[8, 5] and σ[5, 1] are determined by sequentially tracing the parents. In this case, the number of accesses to the shortest path matrix is two for each of σ[8, 5] and σ[5, 1]. The number of accesses to the shortest path matrix is five in total, and is increased by one, compared with the case where only the vertex number of the parent is used described above. For σ[8, 5] and σ[5, 1] as well, when the intermediate point is used, the number of accesses to the shortest path matrix is increased by one, so that the number of accesses is increased by three in total. In this way, when the intermediate point is used as the value of the element of the shortest path matrix, the number of accesses to the shortest path matrix is increased by one for one intermediate point.

Next, consider a case in which the intermediate edge number of the intermediate edge is used as the value of the element of the shortest path matrix. Suppose that S[8, 1]=9, and the 9 represents the intermediate edge number of the intermediate edge (5, 3). Therefore, it may be calculated as σ[8, 1]=σ[8, 5]+[5, 3]+σ[3, 1]. Up to this point, the shortest path matrix is accessed once and the intermediate path table is accessed once. In a case where σ[8, 5] and σ[3, 1] are determined by a method in which the parents are sequentially traced, the shortest path matrix is accessed twice for σ[8, 5] and once for σ[3, 1]. Therefore, in total, the shortest path matrix is accessed 4 times, and the intermediate path table is accessed once. For example, the number of accesses to the intermediate path table is increased by one, compared with the case where only the vertex number of the parent is used.

Consider a path having a length of 2 or more as the intermediate path. Suppose that S[8, 1]=10, and the 10 represents an intermediate path of [7, 5, 3] having a length of 2 or more. Therefore, σ[8, 1]=σ[8, 7]+[7, 5, 3]+σ[3, 1]. Up to this point, the shortest path matrix is accessed once and the intermediate path table is accessed once. In a case where σ[8, 7] and σ[3, 1] are determined by a method in which the parents are sequentially traced, the shortest path matrix is accessed once for σ[8, 7] and once for σ[3, 1]. Therefore, in total, the shortest path matrix is accessed three times, and the intermediate path table is accessed once. For example, the number of accesses to the shortest path matrix has been decreased by one, compared with the case where only the vertex number of the parent is used, but the number of accesses to the intermediate path table has been increased by one.

Access to the shortest path matrix and access to the intermediate path table may not have the same processing load. This is because there is a possibility that the input/output count differs depending on the difference in compression ratio or the arrangement of data, or the processing load on the CPU differs. In a case where the access to the shortest path matrix has heavier processing load than the access to the intermediate path table, if the intermediate path length is 2 or more, use of the intermediate path as the value of the element of the shortest path matrix allows the shortest path matrix to be restored at a higher speed than when only the vertex number of the parent is used.

On the other hand, in a case where the access to the shortest path matrix has lighter processing load, if the intermediate path length is an integer equal to or larger than 2, it is probable that there is a value for which the shortest path matrix may be restored at a higher speed than when only the vertex number of the parent is used. In the present embodiment, description will be made in which this value is set to a minimum intermediate path length (Lₘᵢₙ), and only the identification information (hereinafter referred to as an intermediate path number) of the intermediate path whose intermediate path length is equal to or larger than Lₘᵢₙ is used as a value of an element of the shortest path matrix. In the present embodiment, a case when Lₘᵢₙ=2 will be described.

The longer the intermediate path used for the shortest path matrix, the smaller the number of accesses to the shortest path matrix at the time of restoration of the shortest path. However, even if the intermediate path is lengthened, the number of accesses may not be reduced. Because there should not be so many shortest paths including the long intermediate path. Although the relationship between the intermediate path length and the number of accesses may not be unconditionally determined, it is expected that there is a trade-off relationship between the size of the intermediate path table and the number of accesses. For example, it is expected that when the size of the intermediate path table increases, the number of accesses decreases, and, to the contrary, when the size of the intermediate path table decreases, the number of accesses increases. In an excessive example, in a case where the number of accesses to the shortest path matrix is minimized, the number of accesses to the shortest path matrix is only one when all the shortest paths are managed by using the intermediate path table. However, in this case, the size of the intermediate path table is enormous. On the other hand, in a case where the size of the intermediate path table is minimized, the intermediate path table may not include the intermediate path. However, the number of accesses to the shortest path matrix in this case is the same as the number of accesses when only the vertex number of the parent is used.

It is therefore desirable to be able to adjust to so as to reduce the number of accesses to the shortest path matrix as much as possible while keeping the size of the intermediate path table as small as possible. In the present embodiment, a case where such adjustment is made will be described.

First, the outline of the embodiment will be described below. Details of each item will be described later.

(1) To cluster a graph and determine a cut point.

(2) To generate a vertex cluster correspondence table and intermediate path tables P₁ and P₂.

(3) To generate a shortest path matrix using the intermediate path number of the intermediate path whose length is not less than the minimum intermediate path length (Lₘᵢₙ).

(4) To compress the shortest path matrix and the intermediate path table P₂.

As described above, the length of the intermediate path is required to be adjusted such that the number of accesses to the shortest path matrix is reduced as much as possible while keeping the size of the intermediate path table as small as possible. This is why the graph is clustered as written in (1) above. As a result of clustering, the graph is divided into a plurality of clusters connected by cut edges. The cut edge is an edge whose vertex at one end and vertex at the other end belong to different clusters. The vertexes at both ends of the cut edge are called cut points. The shortest path is used as the intermediate path wherein the cut points of each cluster are the start point and the end point, and the shortest path whose length is equal to or larger than the minimum intermediate path length Lₘᵢₙ consists only of the vertexes included in the cluster.

As illustrated in FIG. 8, an information processing apparatus 100 according to the present embodiment includes a shortest path matrix generation unit 10 including an assignment unit 12 and a generation unit 14, and a shortest path restoration unit 20 including a restoration unit 22. The shortest path matrix generation unit 10 is an example of a shortest path matrix generation apparatus of the disclosed technology, the assignment unit 12 is an example of an assignment unit of the disclosed technology, and the generation unit 14 is an example of a generation unit of the disclosed technology.

The assignment unit 12 divides (clusters) the input graph into a designated number of partial graphs. A known method may be used as a clustering method. For each partial graph, the assignment unit 12 assigns an intermediate path number to the intermediate path wherein the intermediate path is represented using the vertexes included in the partial graph and has the cut point as the start point and the end point.

For example, when G=(V, E) where 1≤i≤p, as described below, the assignment unit 12 divides the graph G into the rows G₁, G₂, . . . , Gₚ of the partial graph Gᵢ=(Vᵢ, Eᵢ) consisting of Vᵢ and a set of edges Eᵢ consisting of vertexes whose ends are included in Vᵢ.

Gᵢ=(Vᵢ,Eᵢ)

Eᵢ={(v₁,v₂)∈E|v₁,v₂∈Vᵢ}

As described above, dividing one graph into a plurality of graphs is referred to as “clustering” as described above, and each connected partial graph Gᵢ (i=1, 2, . . . , P) is referred to as a “cluster”. In the following, p is referred to as “number of clusters”. With this clustering, it is possible to divide the graph G into p connected partial graphs without overlapping each other and determine cut points. Each partial graph Gᵢ is connected.

In a case where there is a path from one to the other for any two vertexes in a partial graph of an undirected graph, the partial graph is said to be connected, and the partial graph which is connected is referred to as a connected partial graph.

In dividing the graph, as described above, in consideration of adjusting so as to reduce the number of accesses to the shortest path matrix as much as possible while keeping the size of the intermediate path table as small as possible, the restriction conditions are set to satisfy the following two requests to the utmost.
1) The number of vertexes included in each Vᵢ is equal.
2) The number of cut edges is small.

In a case where the edge e=(v₁, v₂) extends over two graphs G₁=(V₁, E₁) and G₂=(V₂, E₂), for example, v₁∈V₁, and v₂∈V₂, the vertexes v₁ and v₂ are “cut points”, and the edge e is a “cut edge”. For example, the fact that the number of cut edges is small means that the number of edges extending over the p partial graphs G₁, G₂, . . . , Gₚ, for example, the number of edges not included in any Gᵢ is small.

As described above, the assignment unit 12 uses the shortest path as the intermediate path wherein the cut points in each cluster Gᵢ are the start point and the end point, and the shortest path whose length is equal to or larger than the minimum intermediate path length Lₘᵢₙ consists only of the vertexes included in the cluster Gᵢ.

Since the cluster is determined by the value of p and the intermediate path is also determined by the value of p, the size of the intermediate path table for managing the intermediate path is determined. The value of p may be set to an appropriate value based on the size of the entire graph. However, in order to set it to an appropriate value, attention as described below is requested. For example, since when p is increased to approach n, the average length of the intermediate path is decreased, it seems that the number of accesses to the shortest path matrix increases. However the number of the shortest paths in which the intermediate path may be used may increases, and, to the contrary, the number of accesses may be reduced. In this case, as mentioned above, the size of the intermediate path table is expected to be increased. To the contrary, when p is reduced, the average length of the intermediate path is large, and it seems that the number of accesses to the shortest path matrix decreases. However, the shortest path in which the intermediate path may be used decreases, and the number of accesses may be increased. In this case, the size of the intermediate path table is expected to be decreased. Thus, the number of accesses to the shortest path matrix and the size of the intermediate path table which are expected to be in a trade-off relationship change by varying p. As described above, although, unlike the case of the relationship between p and the average intermediate path length, the change in the relationship may not be predicted, it is possible to perform a balanced adjustment that seems to be optimum for users by varying the at least value of p within an appropriate range from 1 to n.

The assignment unit 12 generates a vertex cluster correspondence table indicating which cluster each vertex belongs to. For example, the assignment unit 12 generates a vertex cluster correspondence table C with an index attached table in which the vertex number i is a key, and the number k of the cluster Gₖ to which the vertex i belongs is a value. In the present embodiment, in an index attached table T, the value for key x is represented by T[x]. Therefore, in the case of the vertex cluster correspondence table C, the value of the vertex cluster correspondence table C for key i is represented by C[i]. For example, C[i]=k. The index attached table is a table that may enable direct access to the value using the index from the key, for example, a hash table or a binary tree on a main storage, or a B-tree or a hash table on a secondary storage.

When there is an intermediate path of [k₁, k₂, . . . , K_{L+1}] where 2≤L, for example, an intermediate path of σ[k₁, k_{L+1}] having a length L, on the shortest path σ[i, j], the assignment unit 12 assigns an intermediate path number to the intermediate path and manages the information of the intermediate path by using the intermediate path table. By managing the information of the intermediate path of [k₁, k₂, . . . , k_{L+1}] by using the intermediate path table, the intermediate path number may be used as the value of the element of the shortest path matrix as in the edge number of the intermediate edge in the reference example. By setting the intermediate path number of the intermediate path having a length L as the value of the element of the shortest path matrix, it is possible to reduce the number of accesses to the shortest path matrix by L−1.

The assignment unit 12 generates, as the intermediate path table, an intermediate path table P₁ and an intermediate path table P₂ for managing the intermediate path used in the shortest path matrix. The intermediate path table P₁ is used when referring to the intermediate path number assigned to each intermediate path at the time of generating the shortest path matrix. The intermediate path table P₂ is used when specifying the intermediate path indicated by the intermediate path number used in the shortest path matrix at the time of restoring the shortest path. For example, the assignment unit 12 may generate each of the intermediate path tables P₁ and P₂ with the index attached table.

For example, when the start point of the intermediate path is i and the end point of the intermediate path is j, the assignment unit 12 defines the key of the intermediate path table P₁ as a tuple(i, j) with i and j, and defines i as “start”, and j as “end” of (i, j). Accordingly, when key=(i, j) in the intermediate path table P₁, the value of i may be referred to in key.start, and the value of j may be referred to in key.end. The assignment unit 12 assigns an intermediate path number to the intermediate path having the start point i and the end point j and stores the intermediate path number as the value of P₁[(i, j)], thereby generating the intermediate path table P₁.

When the intermediate path is [i₁, i₂, . . . , iₕ], and the intermediate path number of this intermediate path is uno, the assignment unit 12 sets the key of the intermediate path table P₂ to uno and stores [i₁, i₂, . . . , iₕ] as the key of P₂[uno], thereby generating the intermediate path table P₂. [i₁, i₂, . . . , iₕ] is a list composed of vertices i₁, i₂, . . . , and iₕ.

For example, the assignment unit 12 determines the shortest path between cut points in Gₖ for each cluster Gₖ (k=1, 2, . . . , P) using an algorithm for determining an existing shortest path. For example, it is possible to determine the breadth-first search algorithm to be described below by using an algorithm that terminates at the time of reaching all the cut points with the cut point as the starting point, instead of determining the shortest path from all points to all points.

For example, in a case where the number of all the vertexes is n, the assignment unit 12 assigns an intermediate path number sequentially from n+1 to each determined intermediate path and associates the intermediate path numbers with respective intermediate paths to register the associated intermediate paths in the intermediate path tables P₁ and P₂. In order to reduce the sizes of the intermediate path tables P₁ and P₂, the key (i, j) of the intermediate path table P₁ satisfies i<j. An intermediate path which corresponds to the key (j, i), and which is reverse to the intermediate path corresponding to the key (i, j), is not stored in the intermediate path table P₁. P1[(i, j)] is used for the intermediate path having the start point j and the end point i. Similarly, with respect to the intermediate path table P₂, when the intermediate path of the intermediate path number uno is [i₁, i₂, . . . , iₕ], only the intermediate path that satisfies i₁<iₕ is stored. [iₕ, iₕ₋₁, . . . , i₁] is used by reversing the order of P₂[uno]=[i₁, i₂, . . . , iₕ]. In order to indicate the reversal, a value obtained by inverting the intermediate path number uno is used as the value of the shortest path matrix as described later.

The generation unit 14 generates the shortest path matrix S using the intermediate path managed using the intermediate path table P₁ as in the generation unit 14R in the reference example.

A method of generating the shortest path matrix generation in the present embodiment is a modification of an existing algorithm for determining the shortest path from all the vertexes to all the vertexes, for example, a modification of the breadth-first search algorithm. Therefore, in order to facilitate understanding of the method of generating the shortest path matrix generation in this embodiment, first, generation of the shortest path matrix by the breadth-first search algorithm will be described. In this method, the vertex number of the parent is stored in the element of the shortest path matrix.

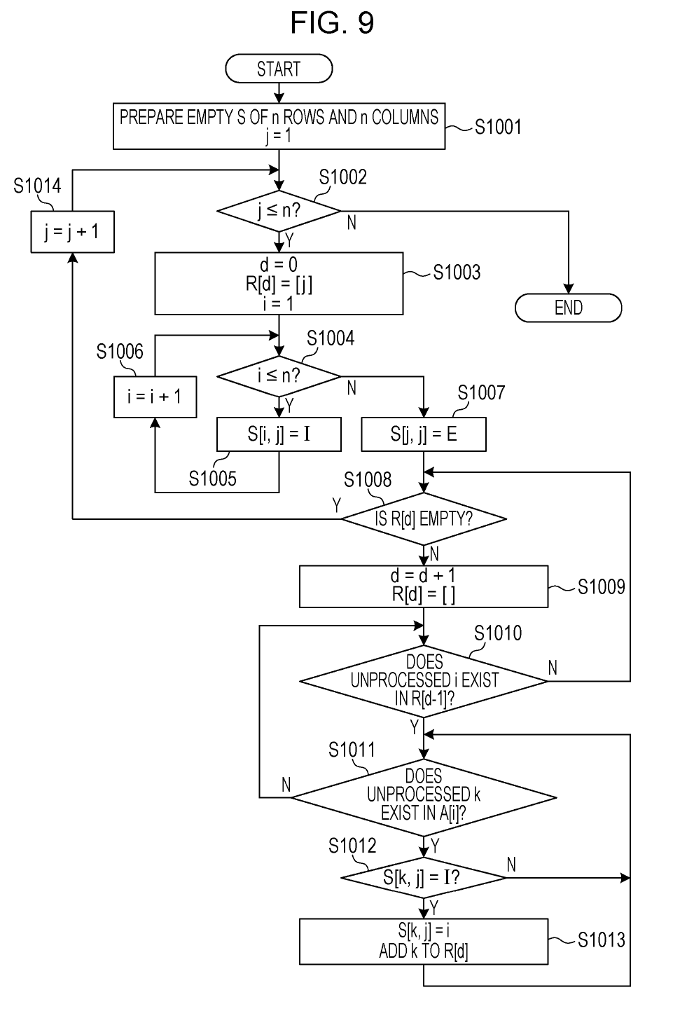

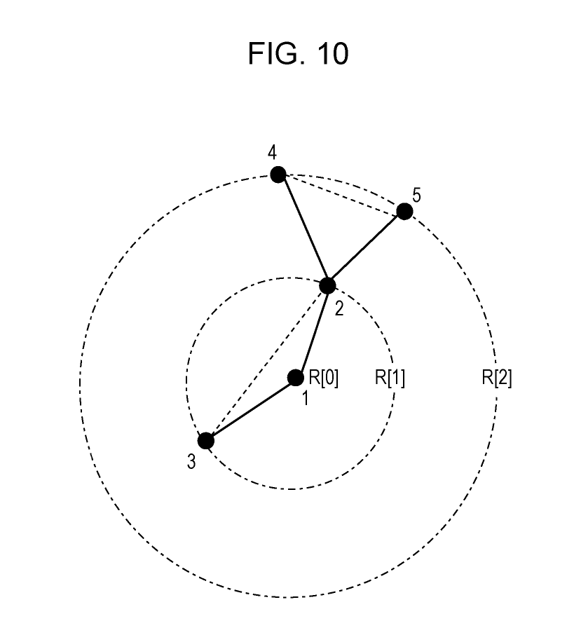

First, for each vertex j, a list of vertex numbers of vertexes adjacent to the vertex (hereinafter referred to as “adjacent vertex list”) A[j] is given. For example, in a case where the vertexes adjacent to vertex j are k₁ and k₂, A[j]=[k₁, k₂]. As explained in detail in the breadth-first search algorithm illustrated in FIG. 9, vertexes having distances of 0, 1, 2, . . . from the vertex j are sequentially and concentrically determined. The state of this concentric behavior is illustrated in FIG. 10. FIG. 10 is an example of a graph including a vertex 1, a vertex 2, a vertex 3, a vertex 4, and a vertex 5, with vertex 1 as the root. In the graph illustrated in FIG. 10, the edge indicated by the solid line represents the edge which has been traced as the shortest path by the breadth-first search algorithm, and the edge indicated by the broken line represents the edge which has not been traced as the shortest path.

For example, in S1001 of the breadth-first search algorithm illustrated in FIG. 9, an empty shortest path matrix S of n rows and n columns is prepared, and a variable j for specifying the end point of the column to be processed in a shortest path matrix S, for example, the end point of the shortest path to be determined, is set to 1.

Next, in step S1002, it is determined whether j is equal to or less than the number n of vertexes included in the graph. In a case where j≤n, in step S1003, 0 is set to the variable d indicating the distance from the vertex j, and j is stored in the list R[d] of vertexes existing on the concentric circle whose distance from the vertex j is d. 1 is set to the variable i for specifying the start point of the shortest path to be determined.

Next, it is determined in step S1004 whether i is less than or equal to n. In a case where i≤n, “I” is stored as an initial value in S[i, j] in step S1005. The vertex number of the parent of the vertex i in the shortest path from the vertex i to the vertex j is stored in the element S[i, j] of the shortest path matrix S. As the initial value, a value I (meaning Initial) indicating that the vertex i has not yet been traced in the search of the shortest path is stored.

In step S1006, i is incremented by 1, and the process returns to step S1004. In a case where it is determined in step S1004 that i>n, a value (here, “E”) indicating the end point of the shortest path is set to S[j, j] in step S1007.

Next, it is determined in step S1008 whether R[d] is empty, and in a case where it is not empty, the process proceeds to step S1009. In step S1009, d is incremented by 1, and R[d] is initialized with an empty list ([ ]).

Next, it is determined in step S1010 whether the vertex i whose processes after this step have not been performed exists in R[d−1]. In a case where the unprocessed vertex i exists, the process proceeds to step S1011, and in a case where no unprocessed vertex i exists, the process returns to step S1008.

In step S1011, one unprocessed vertex i is selected from R[d−1], and it is determined whether the vertex k whose processes after this step have not been performed exists in the adjacent vertex list A[i] for the vertex i. In a case where the unprocessed vertex k exists, the process proceeds to step S1012, and in a case where no unprocessed vertex k exists, the process returns to step S1010.

In step S1012, one unprocessed vertex k is selected from A[i], and it is determined whether S[k, j] is I, for example, an initial value. In a case where S[k, j]=I, the process proceeds to step S1013, and in a case where S[k, j]≠I, the process returns to step S1011.

In step S1013, the vertex number i of the vertex selected in step S1011 is stored in S[k, j] of the shortest path matrix S. The vertex number k of the vertex selected in step S1012 is added to R[d]. For example, the vertex number of a vertex found to be a vertex located at a distance d from the vertex j is stored in R[d] (d=0, 1, 2, . . . ). The process returns to step S1011.

In a case where it is determined in step S1008 that R[d] is empty, j is incremented by 1 in step S1014, and the process returns to step S1002. In a case where it is determined that j>n, the breadth-first search algorithm ends.

The above processing will be described more specifically with reference to the graph illustrated in FIG. 10 as an example.

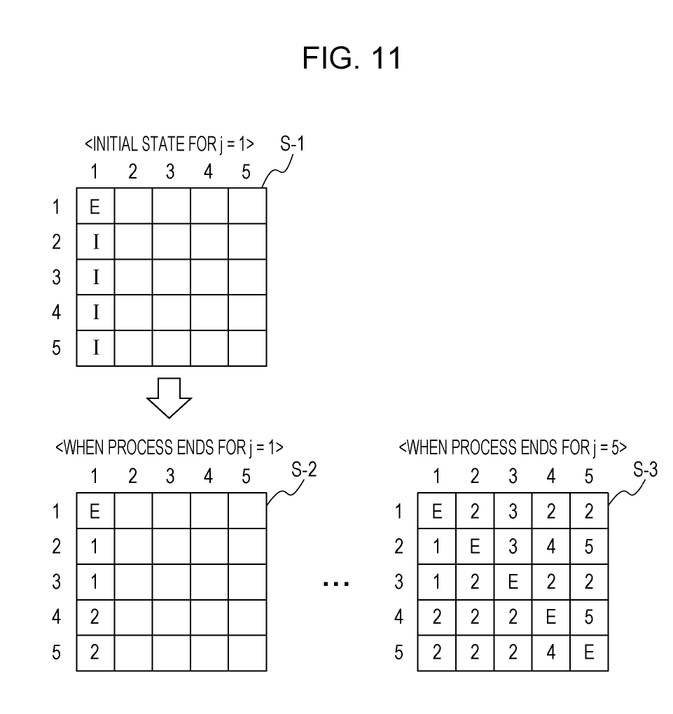

In the case of j=1, when the processes from steps S1002 to S1007 has been completed, the shortest path matrix S is made to be in the initial state for j=1 as illustrated is S-1 in FIG. 11. At this time, since R[d=0]=[1], the process proceeds to step S1009, and R[d=0+1]=[ ]. “1” is stored in R[d−1=0], and A[i=1]=[k=2, 3]. First, when it is assumed that k=2 is selected in step S1012, S[k=2, j=1]=1 is stored in step S1013, and R[d=1]=[2]. Returning to step S1011, k=3 is selected, and S[k=3, j=1]=1 is stored in step S1013 and R[d=1]=[2, 3].

At this stage, since the unprocessed vertex k does not exist in A[i], and the unprocessed vertex i does not exist in R[d−1], the process returns to step S1008. At this time, since R[d=1]=[2, 3], the process proceeds to step S1009, and R[d=1+1]=[ ]. 2 and 3 are stored in R[d−1=1]. First, when it is assumed that i=2 is selected in step S1011, A[i=2]=[k=1, 3, 4, 5]. First, when it is assumed that k=1 is selected in step S1012, since S[k=1, j=1]=E≠I, the process returns to step S1011. Next, when it is assumed that k=3 is selected, since S[k=3, j=1]=1≠I, the process returns to step S1011. Next, when it is assumed that k=4 is selected, since S[k=4, j=1]=I, S[k=4, j=1]=2 is stored in step S1013 and R[d=2]=[4]. Returning to step S1011, k=5 is selected, and S[k=5, j=1]=2 is similarly stored in step S1013, and R[d=2]=[4, 5].

Next, returning to step S1010, since the unprocessed vertex 3 exists in R[d−1], i=3 is selected in step S1011. Since A[i=3]=[k=1, 2], and even when either k=1 or 2 is selected in step S1012, S[k=1 or 2, j=1]≠I, the process returns to step S1008 via step S1010.

At this time, since R[d=2]=[4, 5], the process proceeds to step S1009, where R[d=2+1]=[ ]. 4 and 5 are stored in R[d−1=2], and when it is assumed that i=4 is selected in step S1011, A[i=4]=[k=2, 5]. In step S1012, even when either k=2 or 5 is selected, since S[k=2 or 5, j=1]≠I, the process returns to step S1010. In step S1011, i=5 is selected and A[i=5]=[k=2, 4]. In step S1012, even when either k=2 or 4 is selected, since S[k=2 or 4, j=1]≠I, the process returns to step S1008 via step S1010.

At this time, since R[d=3] is empty, the process for j=1 ends. The shortest path matrix S at this stage is made to be in the state illustrated in S-2 in FIG. 11. Similar processing is performed for j=2, 3, 4, 5, and at the end of processing for j=5, the shortest path matrix S is made to be in the state illustrated in S-3 in FIG. 11.

Generation of the shortest path matrix in the present embodiment will be described based on the width search algorithm described above. In the generation of the shortest path matrix in the present embodiment, the breadth-first search algorithm is modified as follows.

In the breadth-first search algorithm, the list R[d] in which the vertex number i of the vertex located at a distance d from the vertex j is stored stores, as an element stored in the R[d], not only the vertex number i but also information m on the state of vertex i. For example, in the present embodiment, R[d] is a list of tuple(i, m). The information m on the state of the vertex i is information indicating the state of the vertex i in the process of finding the intermediate path on the shortest path from the vertex i to the vertex j.

In the present embodiment, m is defined as a tuple composed of three elements of m=(state, uno, len). Each element of state, uno, and len may be referred to in m.state, m.uno, and m.len, respectively. m.state represents the state of vertex i (details will be described later). m.uno represents the vertex number of the cut point which is the end point of the intermediate path, or the intermediate path number of the intermediate path. m.len represents the length of the intermediate path. m.state is represented by a number indicating the current state of the path that has been traced. The numbers used for m.state and its meaning are described below.

NP: The vertex i is in a cluster same as that of the starting point of the shortest path search and the intermediate path has not been encountered.

IP: The vertex i is in a cluster different from that of the starting point of the shortest path search and the incomplete intermediate path or the path which has a possibility of being an intermediate path is encountered.

CP: The completed intermediate path whose length is equal to or larger than the minimum intermediate path length Lₘᵢₙ is encountered.

The completion of the intermediate path means that search of the shortest path move to a cluster via a intermediate path whose length is equal to or longer than Lₘᵢₙ where the cluster is different from that of the intermediate path and that it has been confirmed that the intermediate path is not further extended. To the contrary, incompletion means that an intermediate path is encountered on the path, but search does not move from a cluster where there is the intermediate path to another cluster, so that the intermediate path is not completed and may be further extended.

As the values of m.state, for example, numbers which satisfy NP<IP<CP, for example, 0, 1, 2, are allocated to NP, IP, and CP, respectively. NP stands for No Path, IP stands for Incomplete Path, and CP stands for Complete Path. In the following description, explanation will be made using symbols NP, IP, and CP instead of numbers 0, 1, 2, etc. in order to make the description easy to understand.

Depending on the value of m.state, each element of m takes a value described below.

In the case of NP: (NP, None, None)

In the case of IP: (IP, u, len)

In the case of CP: (CP, u, len)

None is a constant that means there is no object. In the case of IP, u is the vertex number of the end point of the path that may be an intermediate path, and len is the length from the vertex i to the end point u of the path. In the case of CP, u is the intermediate path number of the completed intermediate path, len is the length of the intermediate path, and Lₘᵢₙ≤len.

Referring again to FIG. 8, the generation unit 14 determines the shortest path by breadth-first search while updating the above mentioned m and stores the vertex number of the vertex on the shortest path or the intermediate path number of the intermediate path in the corresponding element of the shortest path matrix, thereby generating the shortest path matrix S. The generation unit 14 compresses the generated shortest path matrix S together with the intermediate path table P₂ generated by the assignment unit 12 and stores them in a matrix DB 30.

Upon receiving an inquiry about the shortest path designating the start point and the end point, the restoration unit 22 restores the shortest path between the vertexes corresponding to the designated start point and end point using the shortest path matrix S and the intermediate path table P₂ stored in the matrix DB 30.

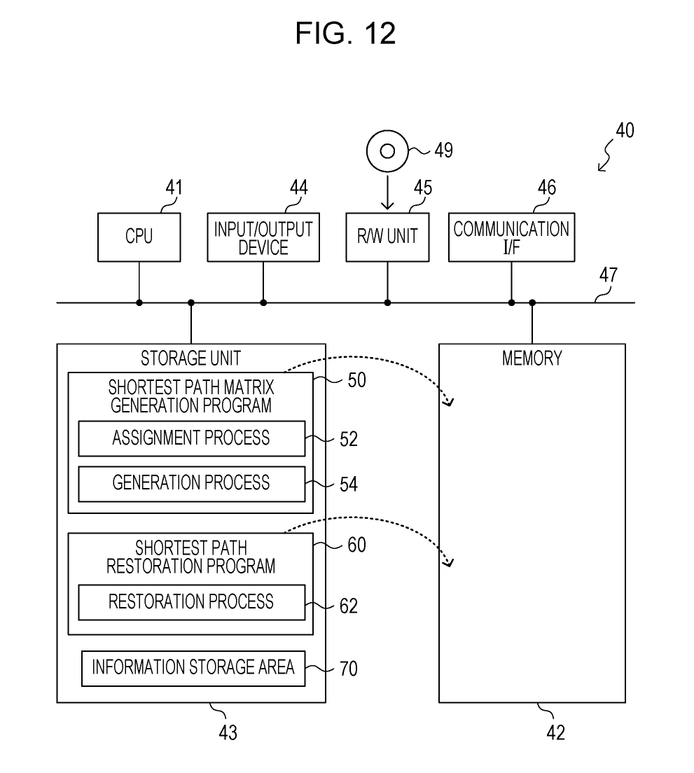

The function of the information processing apparatus 100 may be implemented by, for example, a computer 40 illustrated in FIG. 12. The computer 40 includes a central processing unit (CPU) 41, a memory 42 as a temporary storage area, and a nonvolatile storage unit 43. The computer 40 includes an input/output device 44, a read/write (R/W) unit 45 that controls reading and writing of data to and from a storage medium 49, and a communication interface (I/F) 46 connected to a network such as the Internet. The CPU 41, the memory 42, the storage unit 43, the input/output device 44, the R/W unit 45, and the communication I/F 46 are connected to each other via a bus 47.

The function of the storage unit 43 may be implemented by a hard disk drive (HDD), a solid state drive (SSD), a flash memory, or the like. The storage unit 43 as a storage medium stores a shortest path matrix generation program 50 and a shortest path restoration program 60 for causing the computer 40 to function as the information processing apparatus 100. The shortest path matrix generation program 50 includes an assignment process 52 and a generation process 54. The shortest path restoration program 60 includes a restoration process 62. The storage unit 43 includes an information storage area 70 in which information constituting the matrix DB 30 is stored.

The CPU 41 reads each of the shortest path matrix generation program 50 and the shortest path restoration program 60 from the storage unit 43, develops them in the memory 42, and sequentially executes processes included in the shortest path matrix generation program 50 and the shortest path restoration program 60.

The CPU 41 operates as the assignment unit 12 illustrated in FIG. 8 by executing the assignment process 52. The CPU 41 operates as the generation unit 14 illustrated in FIG. 8 by executing the generation process 54. The CPU 41 operates as the restoration unit 22 illustrated in FIG. 8 by executing the restoration process 62. The CPU 41 reads information from the information storage area 70, for example, develops specific information of the matrix DB 30 into the memory 42, and writes specific information of the memory 42 to the information storage area 70. As a result, the computer 40 that has executed the shortest path matrix generation program 50 and the shortest path restoration program 60 functions as the information processing apparatus 100. The CPU 41 that executes the program is hardware.

The functions implemented by the shortest path matrix generation program 50 and the shortest path restoration program 60 may also be implemented by, for example, a semiconductor integrated circuit, more specifically an application specific integrated circuit (ASIC) or the like.

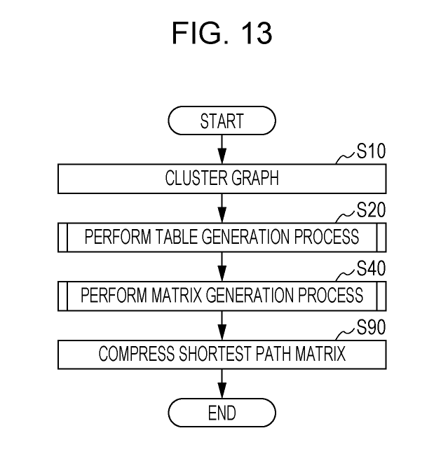

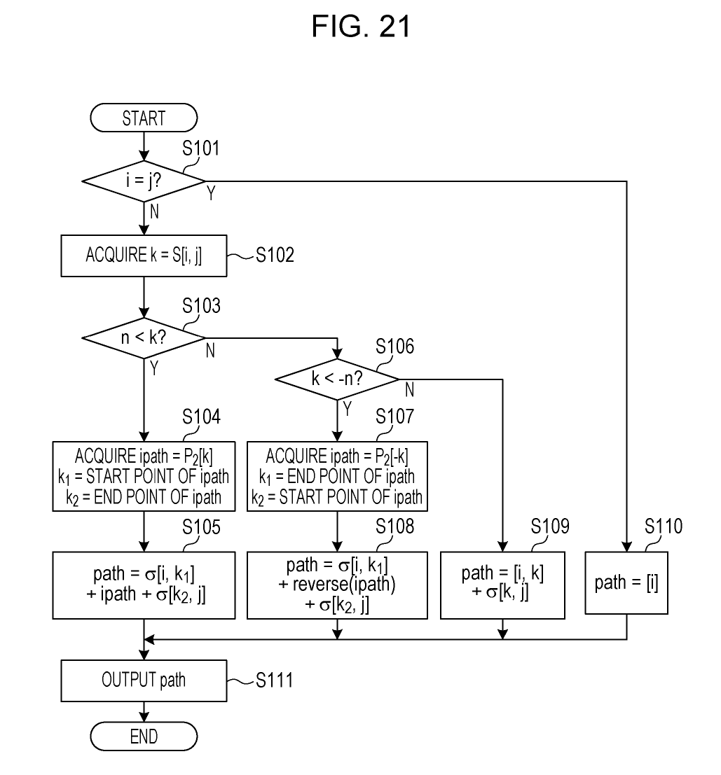

Next, the operation of the information processing apparatus 100 according to the present embodiment will be described. First, when a graph G (G=(V, E)) is input to the information processing apparatus 100 and generation of the shortest path matrix is instructed, a shortest path matrix generation process illustrated in FIG. 13 is performed in the shortest path matrix generation unit 10 of the information processing apparatus 100. The shortest path matrix generation process is an example of a method of generating the shortest path matrix of the disclosed technology. When an inquiry about the shortest path σ[i, j] is accepted in a state where the shortest path matrix is generated and stored in the matrix DB 30, a shortest path restoration process illustrated in FIG. 21 is performed in the shortest path restoration unit 20 of the information processing apparatus 100. Hereinafter, the shortest path matrix generation process and the shortest path restoration process in the present embodiment will be described in detail.

First, in step S10 of the shortest path matrix generation process illustrated in FIG. 13, the assignment unit 12 clusters the graph G into p pieces under the restriction in which 1) the number of vertexes included in each Vᵢ is equal, and 2) the number of cut edges is small.

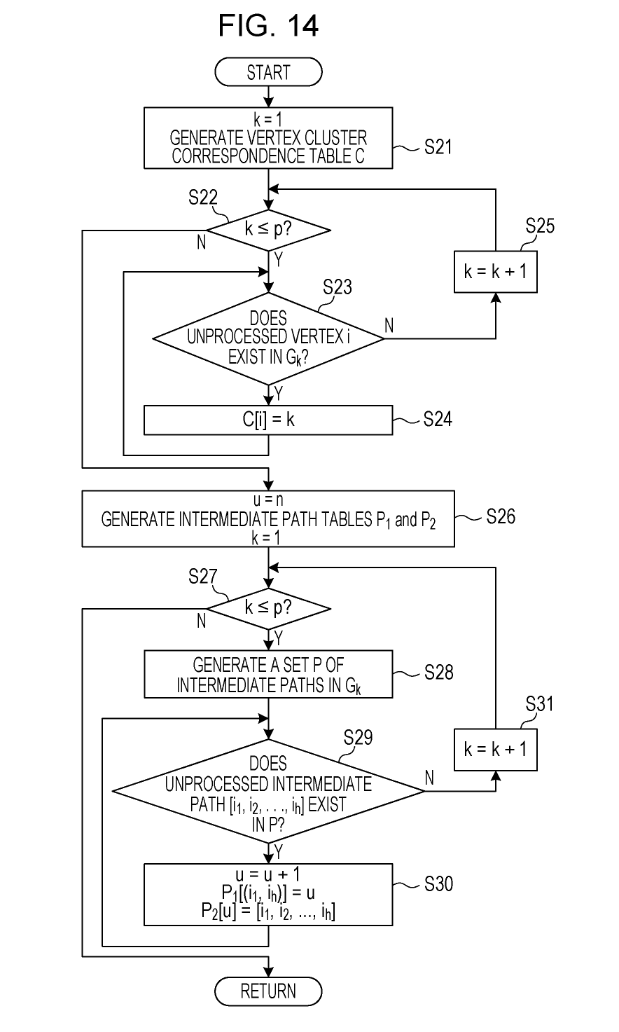

Next, in step S20, a table generation process is performed. Referring to FIG. 14, the table generation process will be described in detail.

In step S21, the assignment unit 12 sets 1 to the variable k indicating the cluster number. The assignment unit 12 generates an empty index attached table as the vertex cluster correspondence table C in the initial state.

Next, the assignment unit 12 determines in step S22 whether k is equal to or less than the number p of clusters divided in step S10. In a case where k≤p, the process proceeds to step S23.

The assignment unit 12 determines in step S23 whether the vertex i whose processes after this step have not been performed is included in the cluster Gₖ. In a case where the unprocessed vertex i is included, the process proceeds to step S24.

In step S24, the assignment unit 12 selects one unprocessed vertex i, and stores k as the value of C[i] in the vertex cluster correspondence table, and the process returns to step S23. When there is no unprocessed vertex in the cluster Gₖ, the process proceeds to step S25. The assignment unit 12 increments k by 1, and the process returns to step S22. In a case where it is determined in step S22 that k>p, the process proceeds to step S26.

In step S26, the assignment unit 12 sets the number n of vertexes (the maximum value of vertex numbers) as the variable u indicating the intermediate path number. The assignment unit 12 generates an empty index attached table as each of the intermediate path tables P₁ and P₂ in the initial state. The assignment unit 12 sets 1 to the variable k indicating the cluster number.

Next, the assignment unit 12 determines in step S27 whether k is equal to or smaller than the number p of clusters. In a case where k≤p, the process proceeds to step S28. In step S28, the assignment unit 12 determines, as an intermediate path, the shortest path that passes through only the vertex included in the cluster Gₖ with the cut point of the cluster Gₖ as the start point and the end point, and generates a set P of intermediate paths. In a case where the start point of the intermediate path is i₁ and the end point is iₕ, only the intermediate path satisfying i₁<iₕ is generated. For example, the breadth-first search algorithm described above may be used as a method of determining the shortest path that is an intermediate path.

Next, the assignment unit 12 determines in step S29 whether intermediate path [i₁, i₂, . . . , iₕ] whose processes after this step have not been performed exists in the set P of intermediate paths. In a case where the unprocessed intermediate path exists, the process proceeds to step S30.

In step S30, the assignment unit 12 increments u by 1, stores u as the value of P₁[(i₁, iₕ)] in the intermediate path table P₁, and stores [i₁, i₂, . . . , iₕ] as the value of P₂[u] in the intermediate path table P₂, and the process returns to step S29. When there is no unprocessed intermediate path in the set P of intermediate paths, the process proceeds to step S31. The assignment unit 12 increments k by 1, and the process returns to step S27. In a case where it is determined in step S27 that k>p, the table generation process ends and the process returns to the shortest path matrix generation process (FIG. 13).

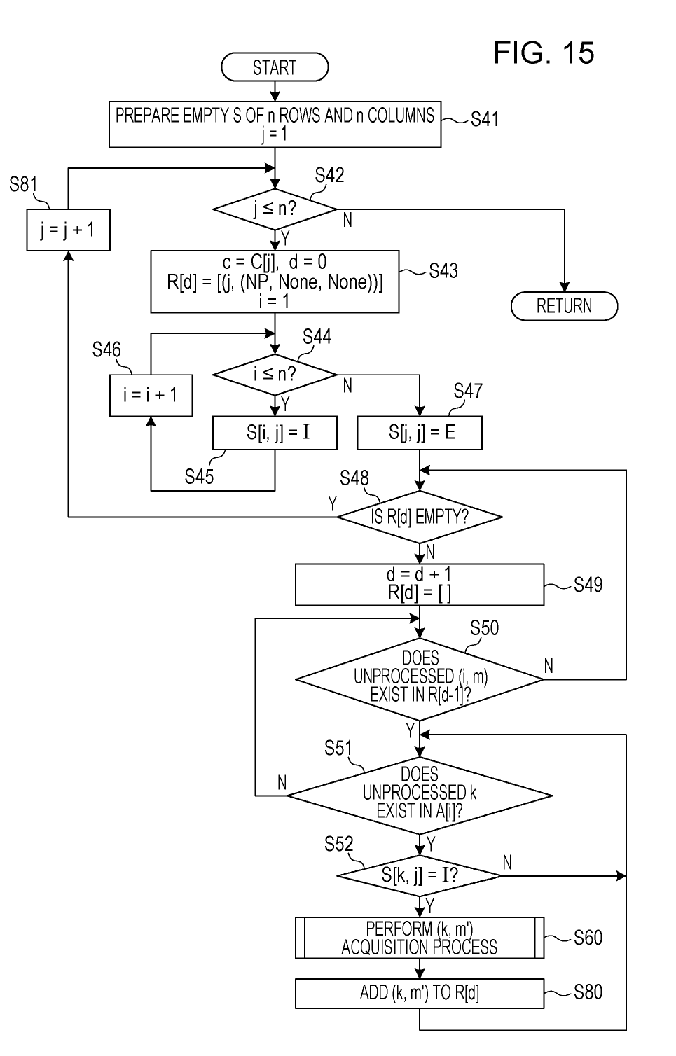

Next, in step S40 of the shortest path matrix generation process, matrix generation process is performed. With reference to FIG. 15, the matrix generation process will be described in detail.

In step S41, the generation unit 14 prepares an empty shortest path matrix S of n rows and n columns, and sets the variable j for specifying the end point of the column to be processed in the shortest path matrix S, for example, the end point of the shortest path to be determined, to 1.

Next, the generation unit 14 determines in step S42 whether j is equal to or smaller than the number n of vertexes included in the graph. In a case where j≤n, in step S43, the generation unit 14 acquires the value of C[j] from the vertex cluster correspondence table C, sets it to the variable c, and sets 0 to the variable d indicating the distance d from the vertex j. The generation unit 14 stores (i, (NP, None, None)) in the list R[d] of the tuple(i, m) of the information m indicating the vertex number i of the vertex existing on the concentric circle whose distance from the vertex j is d, and the state of the vertex i. The generation unit 14 sets 1 to the variable i for specifying the start point of the shortest path to be determined.

Next, in steps S44 to S47, as in steps S1004 to S1007 of the breadth-first search algorithm (FIG. 9) described above, the initial value “I” is set to the element S[i, j](i=1, 2, . . . , n) of the shortest path matrix S, and the value “E” indicating the end point is set to S[j, j].

Next, the generation unit 14 determines in step S48 whether R[d] is empty. In a case where R[d] is not empty, the process proceeds to step S49. In step S49, the generation unit 14 increments d by 1 and initializes R[d] with an empty list ([ ]).

Next, the generation unit 14 determines in step S50 whether the tuple(i, m) whose processes after this step have not been performed exists in R[d−1]. In a case where the unprocessed tuple(i, m) exists, the process proceeds to step S51. In a case where no unprocessed tuple(i, m) exists, the process returns to step S48.

In step S51, the generation unit 14 selects one unprocessed tuple(i, m) from R[d−1], and determines whether the vertex k whose processes after this step have not been performed exists in the adjacent vertex list A[i] of the vertex i. In a case where the unprocessed vertex k exists, the process proceeds to step S52, and in a case where no unprocessed vertex k exists, the process returns to step S50.

In step S52, the generation unit 14 selects one unprocessed vertex k from A[i], and determines whether S[k, j] is I, for example, an initial value. In a case where S[k, j]=I, the process proceeds to step S60, and in a case where S[k, j]≠I, the process returns to step S51.

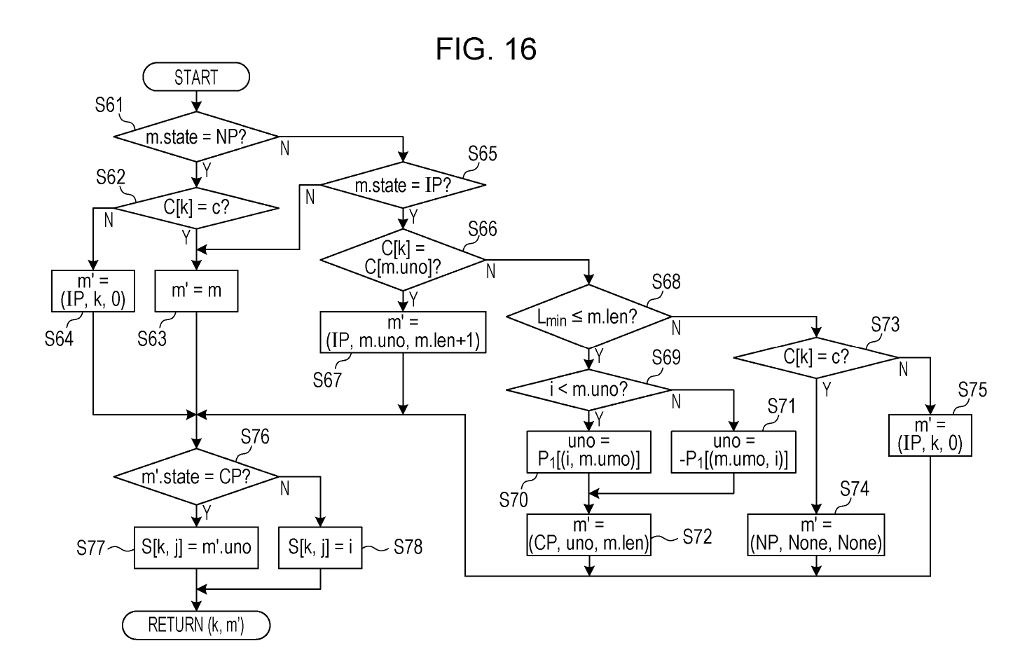

In step S60, the generation unit 14 performs a (k, m′) acquisition process for acquiring the tuple(k, m′) of the information m′ indicating the vertex k and its state when the shortest path is traced from the vertex i to the vertex k. With reference to FIG. 16, the (k, m′) acquisition process will be described.

The generation unit 14 determines in step S61 whether m.state of the tuple(i, m) selected in step S51 is NP. In a case where m.state=NP, the process proceeds to step S62, and in a case where m.state≠NP, the process proceeds to step S65.

The generation unit 14 determines in step S62 whether the value of C[k] in the vertex cluster correspondence table C is the same as the value of c set in step S43. For example, the generation unit 14 determines whether the cluster to which the vertex k belongs is the same as the cluster to which the vertex j belongs. In a case where C[k]=c, the generation unit 14 determines that the vertex k exists in the cluster same as that of the vertex j which is the starting point of the shortest path search, and that the intermediate path managed by using the intermediate path table P₁ has not been encountered. Therefore, the process proceeds to step S63, and the generation unit 14 sets m of the tuple(i, m) selected in step S51 to m′, and the process proceeds to step S76.

On the other hand, in a case where C[k]≠c, the generation unit 14 determines that the vertex k has moved to a cluster different from the cluster to which the vertex j belongs. For example, vertex k is a cut point of another cluster and is the end point of a path that may be an intermediate path. Therefore, the process proceeds to step S64, the generation unit 14 sets (IP, k, 0) to m′, and the process proceeds to step S76.

The generation unit 14 determines in step S65 whether m.state of the tuple(i, m) selected in step S51 is IP. In a case where m.state=IP, the process proceeds to step S66. In a case where m.state≠IP, the generation unit 14 determines that m.state is CP, and the process proceeds to step S63.

The generation unit 14 determines in step S66 whether the value of C[k] in the vertex cluster correspondence table C is the same as the value of C[m.uno]. m.uno is elements of m.uno of the tuple(i, m) selected in the above step S51. In a case where C[k]=C[m.uno], the process proceeds to step S67.

The generation unit 14 determines in step S67 that the vertex k exists in the cluster same as that of the vertex i, and changes m′ from the state of the vertex i represented by m to the value obtained by extending the intermediate path length by one. For example, the generation unit 14 sets (IP, m.uno, m.len+1) to m′, and the process proceeds to step S76.

In step S66, in a case where it is determined that C[k]≠C[m.uno], the determination indicates that the vertex k has moved to a cluster different from that of the vertex i, for example, the intermediate path in which m.uno is the end point has been completed with the vertex i as the start point. Then, the process proceeds to step S68, and the generation unit 14 determines whether the intermediate path length m.len between the vertex i and the vertex m.uno is equal to or larger than the minimum intermediate path length Lₘᵢₙ. In a case where Lₘᵢₙ≤m.len, the process proceeds to step S69.

The generation unit 14 determines in step S69 whether i is smaller than m.uno. In a case where i<m.uno, the process proceeds to step S70. The generation unit 14 acquires the value of P₁[(i, m.uno)] from the intermediate path table P₁, for example, acquires the intermediate path number of the intermediate path whose start point is i and whose end point is m.uno, and sets the value to the variable uno. On the other hand, in a case where i≥m.uno, the process proceeds to step S71. The generation unit 14 acquires the value of P₁[(m.uno, i)] from the intermediate path table P₁ and inverts the sign of the value. For example, the generation unit 14 sets a value obtained by assigning minus to the intermediate path number of the intermediate path whose start point is m.uno and whose end point is i as the intermediate path number of the intermediate path whose start point is i and whose end point is m.uno, and sets the value to the variable uno.

Next, in step S72, the generation unit 14 changes m′ to a value indicating that the intermediate path has been completed at the vertex i. For example, the generation unit 14 sets (CP, uno, m.len) to m′, and the process proceeds to step S76.

On the other hand, in step S68, when it is determined that Lₘᵢₙ>m.len, since the completed intermediate path is not an intermediate path managed by using the intermediate path table P₁, the generation unit 14 determines that the intermediate path has not been encountered, and the process proceeds to step S73.

The generation unit 14 determines in step S73 whether C[k]=c. In a case where C[k]=c, the generation unit 14 determines that the vertex k exists in the cluster same as that of the vertex j which is the starting point of the shortest path search, and that the intermediate path managed by using the intermediate path table P₁ has not been encountered. As a result, the process proceeds to step S74, the generation unit 14 sets (NP, None, None) to m′, and the process proceeds to step S76.

On the other hand, in a case where C[k]≠c, the process proceeds to step S75, the generation unit 14 sets (IP, k, 0) to m′ as in step S64, and the process proceeds to S76.

The generation unit 14 determines in step S76 whether m′.state is CP. In the case of m′.state=CP, the determination indicates that the state of vertex k has changed from IP to CP or was originally CP. As a result, the process proceeds to step S77, and in step S77, the generation unit 14 stores m′.uno, for example, the intermediate path number acquired in step S70 or S71 in the value of S[k, j].

On the other hand, in a case where m′.state≠CP, the process proceeds to step S78, and the generation unit 14 stores the vertex number i of the parent of the vertex k in the value of S[k, j]. The generation unit 14 returns the tuple(k, m′), and the process returns to the matrix generation process (FIG. 15).

Next, in step S80 illustrated in FIG. 15, the generation unit 14 adds the tuple(k, m′) returned from the (k, m′) acquisition process to the list R[d], and the process returns to step S51.

In a case where it is determined in step S48 that R[d] is empty, the process proceeds to step S81, the generation unit 14 increments j by 1, and the process returns to step S42. In a case where it is determined in step S42 that j>n, the matrix generation process ends and the process returns to the shortest matrix generation process (FIG. 13).

Next, in step S90 illustrated in FIG. 13, as in step S3 of the shortest path matrix generation process (FIG. 6) in the reference example, the generated shortest path matrix S and the intermediate path table P₂ generated by the assignment unit 12 are compressed, and stored in a predetermined storage area of the matrix DB 30. The shortest path matrix generation process ends.

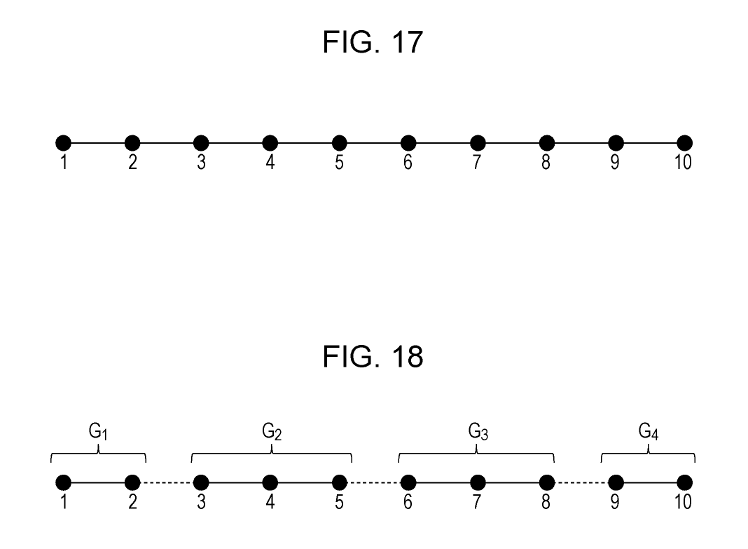

The above-described shortest path matrix generation process will be specifically described using a simple linear graph illustrated in FIG. 17, in particular, focusing on the matrix generation process.

The number n of vertexes included in the graph illustrated in FIG. 17 is 10. Assume that the number p of divisions (number of clusters) is 4, for example, the graph is clustered as illustrated in FIG. 18. In FIG. 18, edges indicated by a broken line are cut edges. For example, a set V of vertexes is divided as follows.

V₁=[1, 2], V₂=[3, 4, 5], V₃=[6, 7, 8], V₄=[9, 10]

V₁, V₂, V₃, and V₄ are included in clusters (connected partial graphs) G₁, G₂, G₃, and G₄, respectively. The cut edge between G₁ and G₂ is (2, 3), the cut edge between G₂ and G₃ is (5, 6), the cut edge between G₃ and G₄ is (8, 9), and the cut points are 2, 3, 5, 6, 8, and 9. Therefore, the vertex cluster correspondence table C is generated as follows.

C[1]=1, C[2]=1,

C[3]=2, C[4]=2, C[5]=2,

C[6]=3, C[7]=3, C[8]=3,

C[9]=4, C[10]=4

The intermediate path table P1 and the intermediate path table P₂ are generated as follows.

P₁[(3, 5)]=11, P₁[(6, 8)]=12,

P₂[11]=[3, 4, 5], P₂[12]=[6, 7, 8]

Next, the operation of the matrix generation process illustrated in FIG. 15 will be specifically described. Hereinafter, a case where the shortest path from each vertex to the end point j (j=1, 2 . . . , 10) is determined with the end point of the shortest path to be determined as j will be described.

In the case of j=1, since C[j=1]=1 in step S43, c=1. R[d=0]=[(j=1, (NP, None, None))] is set.

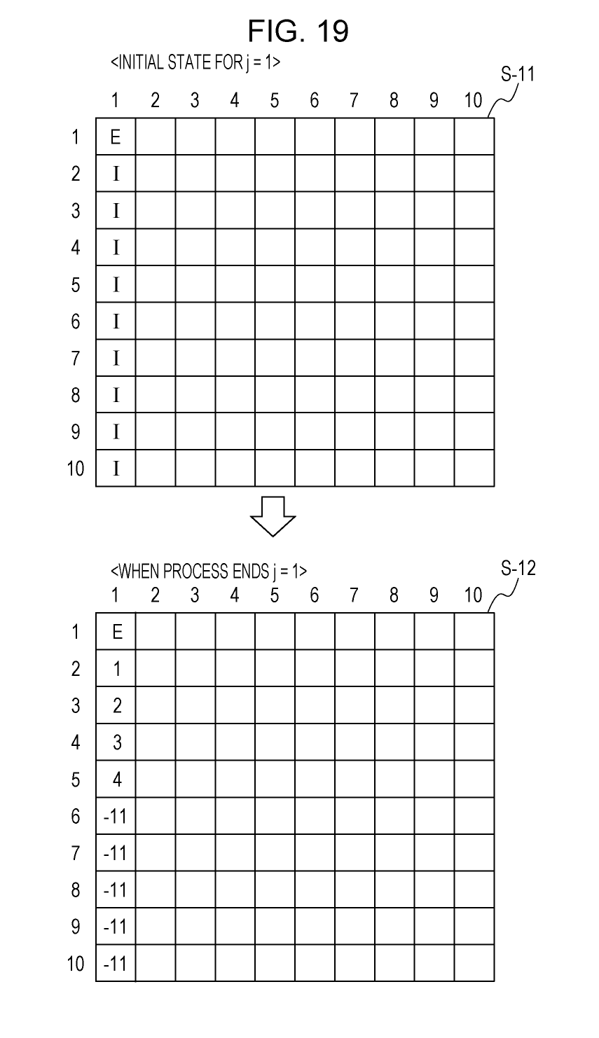

When the processing of steps S44 to S47 is performed, the shortest path matrix S is made to be in the initial state for j=1 as illustrated in S-11 of FIG. 19. At this time, since one tuple is stored in R[d=0], the process proceeds to step S49, where R[d=0+1]=[ ]. A tuple(1, (NP, None, None)) is stored in R[d−1=0], and this tuple is taken out as an unprocessed tuple(i, m) in step S51. For example, i=1, m=(NP, None, None). Since A[i=1]=[2], k=2 is selected in step S52. Since S[k=2, j=1]=I, the (k, m′) acquisition process illustrated in FIG. 16 is performed.

Since m.state=NP, and C[k]=1=c (=1), m′=m in step S63. Since m′.state=NP, S[k=2, j=1]=i (=1) is stored in step S78, and (k=2, m′=(NP, None, None)) is returned. As a result, R[1]=[(2, (NP, None, None))].

At this stage, since the unprocessed vertex k does not exist in A[i], and the unprocessed tuple(i, m) does not exist in R[d−1], the process returns to step S48. At this time, since R[d=1]=[(2, (NP, None, None))], the process proceeds to step S49, where R[d=1+1]=[ ]. At this time, the tuple(2, (NP, None, None)) is stored in R[d−1=1], and this tuple is taken out as an unprocessed tuple(i, m) in step S51. For example, i=2, and m=(NP, None, None). Since A[i=2]=[1, 3], when it is assumed that k=1 is selected in step S52, S[k=1, j=1]≠I, whereby the process returns to step S51.

Next, since k=3 is selected and S[k=3, j=1]=I, the (k, m′) acquisition process illustrated in FIG. 16 is performed. Since m.state=NP, and C[k]=2≠c (=1), m′=(IP, k=3, 0) in step S64. Since m′.state=IP, S[k=3, j=1]=i (=2) is stored in step S78, and (k=3, m′=(IP, k=3, 0)) is returned. As a result, R[2]=[(3, (IP, 3, 0))].

At this stage, since the unprocessed vertex k does not exist in A[i], and the unprocessed tuple(i, m) does not exist in R[d−1], the process returns to step S48. At this time, since R[d=2]=[(3, (IP, 3, 0))], the process proceeds to step S49, where R[d=2+1]=[ ]. At this time, the tuple(3, (IP, 3, 0)) is stored in R[d−1=2], and this tuple is taken out as an unprocessed tuple(i, m) in step S51. For example, i=3, and m=(IP, 3, 0). Since A[i=3]=[2, 4], when it is assumed that k=2 is selected in step S52, S[k=3, j=1]≠I, whereby the process returns to step S51.

Next, since k=4 is selected and S[k=4, j=1]=I, the (k, m′) acquisition process illustrated in FIG. 16 is performed. Since m.state=IP, and C[k]=2=C[m.uno=3] (=2), m′=(IP, m.uno=3, m.len+1=1) in step S67. Since m′.state=IP, S[k=4, j=1]=i (=3) is stored in step S78 and (k=4, m′=(IP, 3, 1)) is returned. As a result, R[3]=[(4, (IP, 3, 1))].

At this stage, since the unprocessed vertex k does not exist in A[i], and the unprocessed tuple(i, m) does not exist in R[d−1], the process returns to step S48. At this time, since R[d=3]=[(4, (IP, 3, 1))], the process proceeds to step S49 where R[d=3+1]=[ ]. At this time, the tuple(4, (IP, 3, 1)) is stored in R[d−1=3], and this tuple is taken out as an unprocessed tuple(i, m) in step S51. For example, i=4, and m=(IP, 3, 1). Since A[i=4]=[3, 5], when it is assumed that k=3 is selected in step S52, S[k=3, j=1]≠I, whereby the process returns to step S51.

Next, since k=5 is selected and S[k=5, j=1]=I, the (k, m′) acquisition process illustrated in FIG. 16 is performed. Since m.state=IP, and C[k]=2=C[m.uno=3] (=2), m′=(IP, m.uno=3, m.len+1=2) in step S67. Since m′.state=IP, S[k=5, j=1]=i (=4) is stored in step S78 and (k=5, m′=(IP, 3, 2)) is returned. As a result, R[4]=[(5, (IP, 3, 2))].

At this stage, since the unprocessed vertex k does not exist in A[i], and the unprocessed tuple(i, m) does not exist in R[d−1], the process returns to step S48. At this time, since R[d=4]=[(5, (IP, 3, 2))], the process proceeds to step S49 where R[d=4+1]=[ ]. At this time, the tuple(5, (IP, 3, 2))) is stored in R[d−1=4], and this tuple is taken out as an unprocessed tuple(i, m) in step S51. For example, i=5, and m=(IP, 3, 2). Since A[i=5]=[4, 6], when it is assumed that k=4 is selected in step S52, S[k=4, j=1]≠I, whereby the process returns to step S51.

Next, since k=6 is selected and S[k=6, j=1]=I, the (k, m′) acquisition process illustrated in FIG. 16 is performed. Since m.state=IP, C[k]=3≠C[m.uno=3] (=2), Lₘᵢₙ (=2)≤m.len=2, and i=5>m.uno=3, P₁[m.uno=3, i=5]=11 is acquired, the sign is inverted, and uno=−11 in step S71. m′=(CP, uno=−11, m.len=2) in step S72. Since m′.state=CP, S[k=6, j=1]=m′.uno (=−11) is stored in step S77 and (k=6, m′=(CP, −11, 2)) is returned. As a result, R[5]=[(6, (CP, −11, 2))].

At this stage, since the unprocessed vertex k does not exist in A[i], and the unprocessed tuple(i, m) does not exist in R[d−1], the process returns to step S48. At this time, since R[d=5]=[(6, (CP, −11, 2))], the process proceeds to step S49 where R[d=5+1]=[ ]. At this time, the tuple(6, (CP, −11, 2)) is stored in R[d−1=5], and this tuple is taken out as an unprocessed tuple(i, m) in step S51. For example, i=6, and m=(CP, −11, 2). Since A[i=6]=[5, 7], when it is assumed that k=5 is selected in step S52, S[k=5, j=1] I, whereby the process returns to step S51.

Next, since k=7 is selected and S[k=7, j=1]=I, the (k, m′) acquisition process illustrated in FIG. 16 is performed. Since m.state=CP, m′=m in step S63. Since m′.state=CP, S[k=7, j=1]=m′.uno (=−11) is stored in step S77 and (k=7, m′=(CP, −11, 2)) is returned. As a result, R[6]=[(7, (CP, −11, 2))].

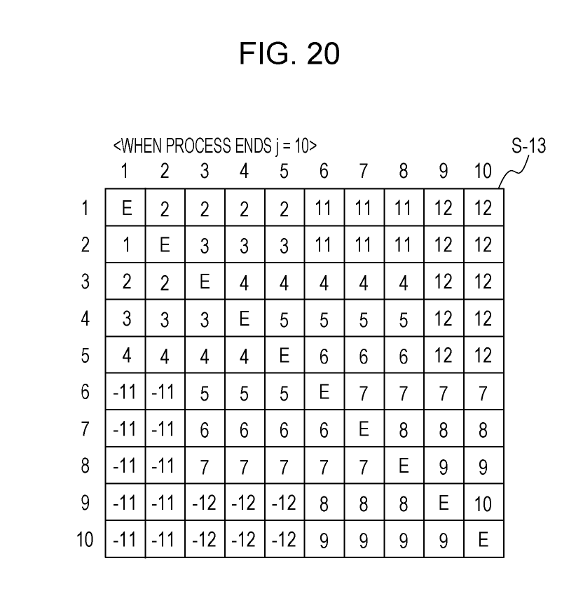

Once m.state=CP, the same processing is performed thereafter, so that S[k=8, j=1]=S[k=9, j=1]=S[k=10, j=1]=−11. Therefore, at the end of j=1, the shortest path matrix S is made to be in the state illustrated in S-12 in FIG. 19. Similar processing is performed for j=2, . . . , 10, and at the end of processing for j=10, the shortest path matrix S is made to be in the state illustrated in S-13 in FIG. 20.

Next, the shortest path restoration process illustrated in FIG. 21 will be described.

In step S101, the restoration unit 22 determines whether i=j for the inquiry about the accepted shortest path σ[i, j]. In a case where i≠j, the process proceeds to step S102, and in a case where i=j, the process proceeds to step S110.

In step S102, the restoration unit 22 accesses the shortest path matrix S stored in the matrix DB 30, and acquires the value k of S[i, j]. At this time, the restoration unit 22 acquires the value k of S[i, j] after decompressing the data of the shortest path matrix S.

Next, in step S103, the restoration unit 22 determines whether the value k acquired in step S102 is greater than the number n (the maximum value of vertex numbers) of the vertexes of the graph G. In a case where n<k, since k represents the intermediate path number, the process proceeds to step S104, the restoration unit 22 acquires, from the decompressed intermediate path table P₂, the intermediate path associated with P₂[k], and sets the associated intermediate path to the variable ipath. The restoration unit 22 sets the start point of ipath as variable k₁ and the end point as variable k₂.

Next, in step S105, the restoration unit 22 restores the shortest path as described below.

path=σ[i,k₁]+ipath+σ[k₂,j]

On the other hand, in a case where it is determined in step S103 that n≥k, the process proceeds to step S106, and the restoration unit 22 determines whether k is smaller than −n. In a case where k<−n, since k represents a value obtained by inverting the sign of the intermediate path number, the process proceeds to step S107, and the restoration unit 22 acquires, from the intermediate path table P₂, the intermediate path associated with P₂[−k], and set the associated intermediate path to the variable ipath. The restoration unit 22 sets the end point of ipath as variable k₁ and the start point as variable k2.

Next, in step S108, the restoration unit 22 restores the shortest path as described below.

path=σ[i,k₁]+reverse(ipath)+σ[k₂,j]

Reverse (ipath) indicates that the vertex column indicated by ipath is reversed.

In a case where the above steps S103 and S106 are negative determination, k represents the vertex number of the parent of the vertex i. As a result, the process proceeds to step S109, and the restoration unit 22 restores the shortest path as described below.

path=[i,k]+σ[k,j]

σ[i, k₁] and σ[k₂, j] in steps S105 and S108 and σ[k, j] in step S109 are determined by recursively performing steps S101 to S110 of the shortest path restoration process.

In a case where it is determined in step S101 that i=j, the restoration unit 22 sets path=[i] in step S110 without accessing the shortest path matrix S.

Next, in step S111, the restoration unit 22 outputs path in response to the inquiry about the shortest path σ[i, j], and the shortest path restoration process ends.

As described above, in the information processing apparatus according to the present embodiment, the shortest path matrix generation unit uses identification information of the intermediate path having a length 2 or more on the shortest path as the value of each element of the shortest path matrix indicating the shortest path between each vertex included in the graph. Thus, it is possible to reduce the number of accesses to the shortest path matrix when restoring the shortest path from the shortest path matrix, and it is possible to restore the shortest path at high speed.

In the above embodiment, when restoring the shortest path from the shortest path matrix, access to the intermediate path table P₂, is requested, wherein the access is unnecessary when only the vertex number of the parent is used for the shortest path matrix, but as will be explained below, its influence is probably small.

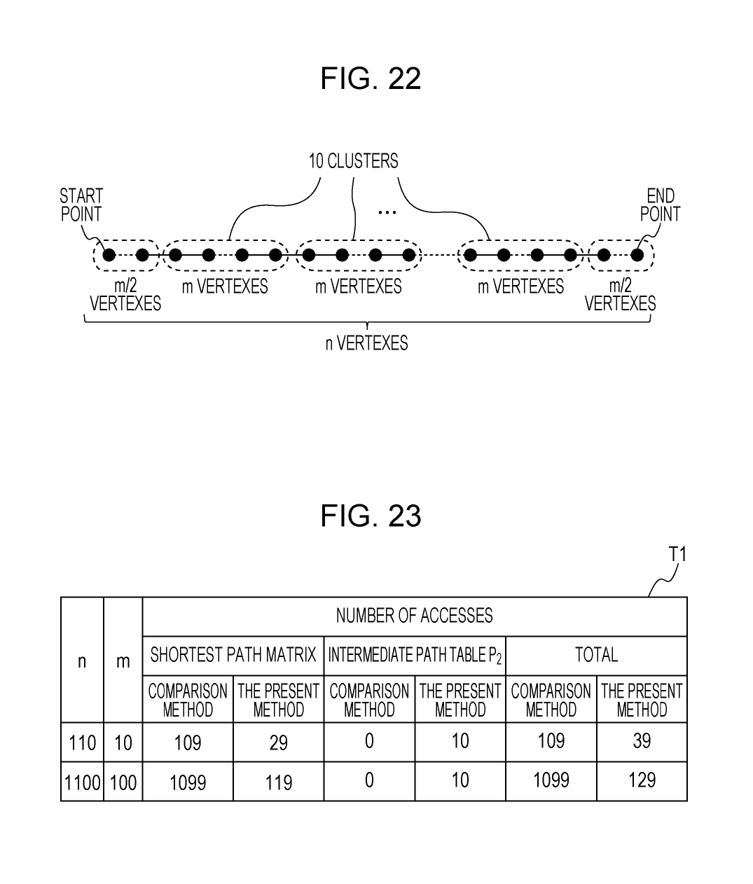

Consider the number of accesses in the shortest path from the start point at the left end to the end point at the right end of the graph in which n vertexes are linearly arranged as illustrated in FIG. 22. The graph is divided into a total of 12 clusters which include two clusters at both end wherein each of them consists of m/2 vertexes and ten clusters between the end clusters wherein each of the ten clusters consists of m vertexes, and each cluster is tied by cut edges. For example, n=11×m holds.

With respect to the number of accesses from the start point to the end point, the method using only the vertex number of the parent for the shortest path matrix (hereinafter referred to as the comparison method) is compared with the method of the above embodiment (hereinafter referred to as the present method). The results are illustrated as a table T1 in FIG. 23. The number of accesses to the shortest path matrix is n−1 in the comparison method, and m+19 (=m/2×2+19) in the present method. In the comparison method, the number of accesses to the intermediate path table P₂ is 0 since the intermediate path table P₂ is not used. In the present method, the number of accesses to the intermediate path table P₂ is ten corresponding to 10 clusters passed in the middle of the process.

As described above, the processing load of the access to the shortest path matrix may be different from that of the access to the intermediate path table P₂. However, assuming that the two processing loads do not greatly differ, the total number of accesses is calculated with the condition in which each processing load is the same. Therefore, the total number of accesses is n−1 in the comparison method and m+29 in the present method. When n=110, the total number of accesses in the present method is about 1/2.8 times that in the comparison method. When n=1100, the total number of accesses in the present method is about 1/8.5 times that in the comparison method.

In the above embodiment, it is possible to balance the size of the intermediate path table P₂ and the number of accesses to the shortest path matrix and the intermediate path table P₂ by adjusting the number p of divisions of the graph.

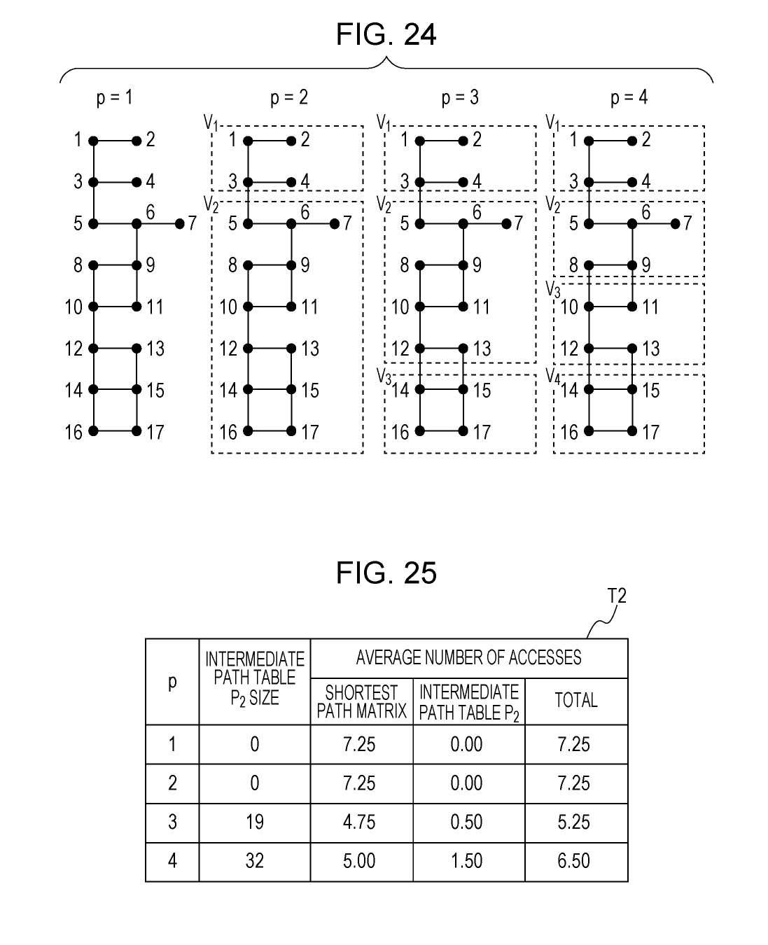

In FIG. 24, a table T2 illustrates an example of clustering in a case where the number p of divisions is changed from 1 to 4 in a graph composed of 17 vertexes. When p=1, the graph in which the number of clusters as a result of division is one represents the original graph which is not divided.

FIG. 25 illustrates the size of the intermediate path table P₂, the average number of accesses to the shortest path matrix and the intermediate path table P₂, and the sum of them for each value of p. The intermediate path table P₂ is generally stored in a disk. However, since the size is small here, it is assumed that the intermediate path table P₂ is in the main storage. In calculating the size of the intermediate path table P₂, it is assumed that the intermediate path table P₂ is a hash table, the number of hash buckets is equal to the number of elements, a next pointer is held for each element, and in order to store the path, its length is also requested to be stores. The average number of accesses is calculated based on the average number of accesses of the four shortest paths from vertexes 2 to 17, 3 to 11, 9 to 17, and 3 to 15.

In a case where the size of the intermediate path table P₂ may be allowed to be merely up to 10, p=1 or p=2 will be selected. In this case, the average total number of accesses is 7.25 for both, whereby either p=1 or p=2 may be selected. On the other hand, in a case where the size of the intermediate path table P₂ may be allowed to be up to 20, p=3 in which the average total number of accesses is small will be selected. Even in a case where the size of the intermediate path table P₂ may be allowed to be up to 40, when p=4, the average total number of accesses is increased to 6.5 although the size of the intermediate path table P₂ further increases, whereby p=3 will be selected. When p=2, the graph is divided into two clusters, but each has only one cut point, so that there is no intermediate path registered in the intermediate path table.

In this example, since the graph is small (the number of vertexes is small), the difference in the number of accesses between the case (p=1, 2) corresponding to the comparison method without using the intermediate path and the case (p=3, 4) in which the intermediate path is used is small, and the difference in the number of accesses between p=3 and p=4 in which the intermediate path is used is small. However, it is expected that the difference is large in a large graph (a graph with a large number of vertexes).

In the above embodiment, the case in which the shortest path matrix representing the shortest path between the vertexes included in the unweighted undirected graph is generated has been described, but the disclosed technique may also be applied to the graph of other modes.

For example, in a case where the clustering of the unweighted undirected graph described in the above embodiment is applied to that of a weighted graph, the clustering of the weighted graph, where it is assumed that the graph has no weight, or the graph has weight all of which is 1, may be made in a manner same as that of the above embodiment. In a case where the clustering of the unweighted undirected graph described in the above embodiment is applied to that of a directed graph, the clustering of the directed graph may be made in a manner same as that of the above embodiment by regarding the directed graph as an undirected graph.

In a case where generation of the intermediate path table in the above embodiment is applied to the weighted graph, a method suitable for the weighted graph may be used in determining the shortest path between the cut points, for example, the intermediate path. For example, it is possible to handle the weighted graph by using Dijkstra's method which is well known as an algorithm for determining the shortest path of a weighted graph instead of using breadth-first search as in the embodiment.

When generation of the intermediate path table in the above embodiment is applied to the directed graph, unlike the case of the undirected graph, the shortest path between all the cut points may not exist. For example, even when an intermediate path from cut point k₁ to k₂ exists, an intermediate path from k₂ to k₁ may not exist. However, this does no matter in generation of the intermediate path table in the above embodiment. Since only the path that may be traced is referred to in both of the two intermediate path tables, it is unnecessary to register a path that may not be traced. In the undirected graph, only intermediate paths satisfying k₁<k₂ are stored for space saving. From the above, in the directed graph, in a case where an intermediate path from k₁ to k2 exists in k₁>k₂, but no intermediate path from k₂ to k₁ exists, the intermediate path from k₁ to k₂ is required to be stored.

In a case where generation of the shortest path matrix using the intermediate path number in the above embodiment is applied to the weighted graph, it is possible to handle the weighted graph by adding the modification as in the above embodiment to the Dijkstra method described above. For example, in the Dijkstra method, vertexes are managed by using their lengths and by using queues with priorities. It is possible to handle the weighted graph by simultaneously managing the value of m mentioned above when the Dijkstra method is performed.

In a case where generation of the shortest path matrix using the intermediate path number in the above embodiment is applied to the directed graph, no shortest path from a certain vertex i to a certain vertex j may exist unless paths are strongly connected. For example, when determining the shortest path from each vertex i to the end point j, in the directed graph, there is possibility that the end point j that may not be reached exists. Therefore, with respect to j that may not be reached, the value of S[i, j] remains I, which is the initial value, at the time when the processing of the algorithm is completed. It is also possible to handle the directed graph by construing this I as meaning that j may not be reached from i.

When the above embodiment is applied to a disconnected graph, it is possible to handle the disconnected graph as follows. In an undirected graph, when the graph is not connected, it is assumed that the graph is disconnected. In a directed graph, in a case where the graph is not connected when the graph is regarded as an undirected graph by ignoring the direction of an edge, the graph is assumed to be disconnected.

First, the graph G is divided into connected partial graphs using an existing method. The graph G is divided into q connected partial graphs G₁, G₂, . . . , G_{q}. Each Gᵢ is assumed to be Gᵢ=(Vᵢ, Eᵢ). In this case, in order to simplify the synthesis of a matrix to be described later, the number from 1 to n assigned to the vertexes of V is assigned so that the vertex number of Vᵢ is smaller than the vertex number of Vⱼ where i<j.

The shortest path matrix Sᵢ and intermediate path table P_{2,i} are generated for each connected partial graph Gᵢ where 1≤i≤q using the method described in the above embodiment. The intermediate path number shall be assigned uniquely over q connected partial graphs starting from n+1. The q shortest path matrix and the intermediate path table thus determined are synthesized as follows.

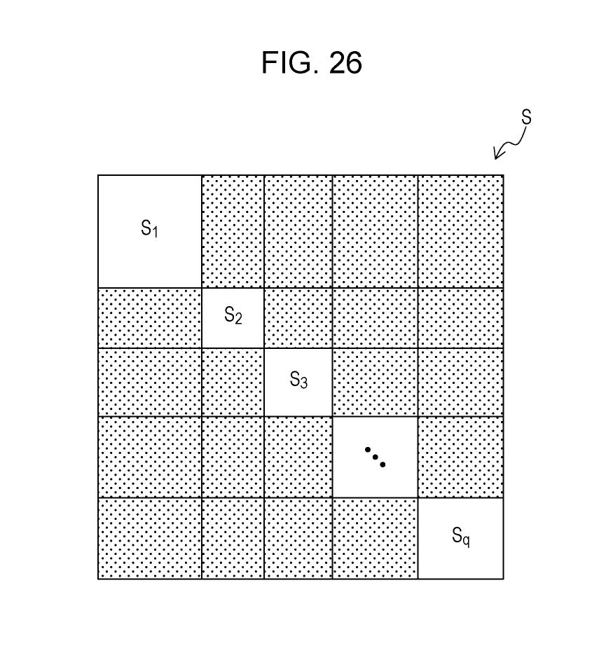

First, synthesis of the shortest path matrix will be described. The q shortest path matrices S₁, S₂, . . . , S_{q} are synthesized as illustrated in FIG. 26 to generate a final shortest path matrix S. I is stored in the shaded elements in FIG. 26 to indicate that there is no path (no parent) as in the case of a directed graph where I indicates no path.

Next, synthesis of the intermediate path table will be described. The intermediate path table that stores the result of synthesis is P₂. The elements of P_{2,i} where 1≤i≤q are sequentially stored in P₂. For example, in a case where the integration number for the intermediate path [i₁, i₂, . . . , iₕ] is uno and P_{2,i}[uno]=[i₁, i₂, . . . , iₕ], P₂[uno]=[i₁, i₂, . . . , iₕ].

In the above embodiment, the case where the intermediate path table is generated before the shortest path matrix is generated has been described, but the implementation of the present disclosure is not limited to the above embodiment. Instead of generating the intermediate path table in advance, an intermediate path table may be generated when the shortest path matrix is generated. For example, the process is as follows.
1) To prepare an empty intermediate path table P₁.
2) To check whether an intermediate path is registered in the intermediate path table P₁ when an intermediate path between cut points is encountered during generation of the shortest path matrix. To register at this time, if not registered.
3) To generate the intermediate path table P₂ only for the intermediate path registered in the intermediate path table P₁.

In order to implement the above, the path after the cut point is stored in m which stores the information on the intermediate path in the shortest path and the state in the process of finding the intermediate path. The process of previously determining the shortest path between the cut points is omitted by adding this improvement, and the intermediate path registered in the intermediate path tables P₁ and P₂ may be narrowed down to the minimum.

In the above embodiment, the mode in which the shortest path matrix generation program 50 and the shortest path restoration program 60 are stored (installed) in advance in the storage unit 43 has been described, but the implementation of the present disclosure is not limited to the above embodiment. The present disclosure may be provided in a form recorded in a storage medium such as a CD-ROM or a DVD-ROM.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer readable storage medium storing a shortest path matrix generation program for causing a computer to execute a process comprising:
assigning, in a graph represented by a plurality of vertexes and edges connecting the vertexes, identification information to respective intermediate paths including two or more of the edges on a shortest path between each vertex; and
generating the shortest path matrix representing the shortest path from all the vertexes to all the vertexes included in the graph, the shortest path matrix having respective elements corresponding to the identification information of the intermediate paths on the shortest path between the vertexes corresponding to a row and a column of the respective elements.

2. The storage medium according to claim 1, wherein the graph is divided into a designated number of partial graphs, and in each of the partial graphs, the intermediate paths are represented using vertexes included in each of the partial graphs, and vertexes which are connected with other partial graphs by edges are regarded as start points and end points of the intermediate paths.

3. The storage medium according to claim 1, the process further comprising:
generating intermediate path tables in which the intermediate paths are associated with the identification information of the intermediate paths; and
referring to the intermediate path tables when the identification information of the intermediate paths is used as the values of the respective elements of the shortest path matrix.

4. The storage medium according to claim 3, wherein an index attached table is used as the intermediate path table.

5. A shortest path matrix generation apparatus comprising:
a memory, and
a processor coupled to the memory and configured to:
assign, in a graph represented by a plurality of vertexes and edges connecting the vertexes, identification information to respective intermediate paths including two or more of the edges on a shortest path between each vertex; and
generate the shortest path matrix representing the shortest path from all the vertexes to all the vertexes included in the graph, the shortest path matrix having respective elements corresponding to the identification information of the intermediate paths on the shortest path between the vertexes corresponding to a row and a column of the respective elements.

6. The shortest path matrix generation apparatus according to claim 5,
wherein the graph is divided into a designated number of partial graphs, and in each of the partial graphs, the intermediate paths are represented using vertexes included in each of the partial graphs, and vertexes which are connected with another partial graph by edges are regarded as a start point and an end point.

7. The shortest path matrix generation apparatus according to claim 6, the processor is further configured to:
generate intermediate path tables in which the intermediate paths are associated with the identification information of the intermediate paths; and
refer to the intermediate path tables when the identification information of the intermediate paths is used as the values of the respective elements of the shortest path matrix.

8. The shortest path matrix generation apparatus according to claim 7, wherein an index attached table is used as the intermediate path table.

9. A shortest path matrix generation method, performed by a computer, the method comprising;
assigning, in a graph represented by a plurality of vertexes and edges connecting the vertexes, identification information to respective intermediate paths including two or more of the edges on a shortest path between each vertex; and
generating the shortest path matrix representing the shortest path from all the vertexes to all the vertexes included in the graph, the shortest path matrix having respective elements corresponding to the identification information of the intermediate paths on the shortest path between the vertexes corresponding to a row and a column of the respective elements.

10. The shortest path matrix generation method according to claim 9, wherein the graph is divided into a designated number of partial graphs, and in each of the partial graphs, the intermediate paths are represented using vertexes included in each of the partial graphs, and vertexes which are connected with another partial graph by edges are regarded as a start point and an end point.

11. The shortest path matrix generation method according to claim 10, the process further comprising:
generating intermediate path tables in which the intermediate paths are associated with the identification information of the intermediate paths; and
referring to the intermediate path tables when the identification information of the intermediate paths is used as the values of the respective elements of the shortest path matrix.

12. The shortest path matrix generation method according to claim 11, wherein an index attached table is used as the intermediate path table.

13. A shortest path matrix generation apparatus comprising:
a memory storing instructions; and
a processor, coupled to the memory, that executes the instructions to perform a process comprising:
determining a shortest path between each of a plurality of vertexes;
assigning, in a graph represented by the plurality of vertexes and edges connecting the vertexes, identification information to respective intermediate paths including two or more of the edges on a shortest path between each vertex;
generating an intermediate path table in which an intermediate edge and an intermediate edge number assigned to the intermediate edge are associated with each other;
determining a value of each element of the matrix representing shortest paths from each of the plurality of vertexes to each of the plurality of vertexes included in the graph;
acquiring a vertex number of an intermediate point from the identification information of the shortest path determined;
selecting a vertex number or an intermediate edge used as a value of an element of the shortest path matrix from vertex numbers of the intermediate points;
acquiring an intermediate edge number from the intermediate path table;
storing the vertex number selected or the intermediate edge number as the value of the element;
compressing the shortest path matrix; and
storing the shortest path matrix compressed with the intermediate path table.
